(19) United States
(12) Patent Application Publication
(10) Pub. No.: US 2022/0111676 A1
(43) Pub. Date: Apr. 14, 2022

(54) OPTICALLY VARIABLE ELEMENT, SECURITY DOCUMENT, METHOD FOR PRODUCING AN OPTICALLY VARIABLE ELEMENT, METHOD FOR PRODUCING A SECURITY DOCUMENT

(71) Applicant: OVD Kinegram AG, Zug (CH)

(72) Inventors: Corrado FRASCHINA, Bonstetten (CH); Sebastian MADER, Baar (CH); Harald WALTER, Horgen (CH)

(21) Appl. No.: 17/278,986

(22) PCT Filed: Sep. 23, 2019
(86) PCT No.: PCT/EP2019/075546

§ 371 Date: Dec. 15, 2021

(30) Foreign Application Priority Data
Sep. 24, 2018 (DE) 10 2018 123 482.1
Dec. 19, 2018 (DE) 10 2018 132 974.1

(51) Int. Cl. B42D 25/328; G02B 3/08; B42D 25/351; B42D 25/355

(52) U.S. Cl. CPC B42D 25/328; B42D 25/355; B42D 25/351; G02B 3/08

(57) ABSTRACT

An optically variable element, in particular a security element and/or a decorative element, preferably for security documents, wherein the optically variable element has at least one pixel array having two or more pixels, wherein one or more pixels of the two or more pixels have one or more structures, and wherein one or more structures of the one or more structures project, diffract and/or scatter incident electromagnetic radiation at one or more solid angles. A security document, in particular comprising one or more optically variable elements, a method for producing an optically variable element, preferably a security element and/or a decorative element, preferably for security documents as well as a method for producing a security document, preferably comprising one or more layers, preferably comprising one or more optically variable elements.

The invention relates to an optically variable element, in particular a security element and/or a decorative element, a security document, a method for producing an optically variable element, as well as a method for producing a security document.

Security elements are used in order to increase, and thus to improve, the protection against forgery of security documents, such as for example banknotes, passports, check cards, visas, credit cards, certificates and/or similar value or identification documents. Further, the optically variable effects provided by the security elements can be easily and clearly detected by a layperson without further technical aids or by means of further technical aids, such as for example cameras, wherein the layperson can verify the authenticity of a security document equipped with a security element of this type with as little effort as possible and can recognize attempts to manipulate the security document and/or forged security documents as promptly as possible.

Diffractive structures and thin-film elements are frequently used as security elements. In this case diffractive structures display color effects, such as for example a rainbow effect, in dependence on the viewing angle. In contrast, thin-film elements are characterized by a defined color-change effect. However, due to their widespread distribution and the resulting familiarization effect, security elements of this type are scarcely noticed by the layperson any more.

Thus, a security element of this type is known, for example, from document DE 10 2004 016 596 A1.

The object of the present invention is therefore to provide an improved optically variable element, a security document comprising one or more improved optically variable elements, a method for producing an improved optically variable element as well as a method for producing a security document comprising one or more improved optically variable elements. In particular, the improved optically variable element provides a particularly memorable optically variable effect.

The object is achieved by an optically variable element, in particular a security element and/or a decorative element, preferably for security documents, wherein the optically variable element has at least one pixel array comprising two or more pixels, wherein one or more pixels of the two or more pixels of the at least one pixel array have one or more structures, and wherein one or more structures of the one or more structures project, diffract and/or scatter incident electromagnetic radiation at one or more solid angles.

The object is further achieved by a security document, in particular comprising one or more optically variable elements.

The object is further achieved by a method for producing an optically variable element, preferably a security element and/or a decorative element, preferably for security documents, which is characterized by the following steps:
providing at least one virtual pixel array comprising two or more virtual pixels,
allocating at least one solid angle to one or more virtual pixels of the two or more virtual pixels of the at least one virtual pixel array,
arranging one or more virtual field sources in and/or on at least one area or at least one segment of the at least one allocated solid angle, wherein the at least one area or the at least one segment of the at least one allocated solid angle is arranged at a first distance from the one or more virtual pixels of the two or more virtual pixels of the at least one virtual pixel array,
calculating one or more virtual electromagnetic fields emanating from the one or more virtual field sources at a predefined distance from the one or more virtual pixels of the two or more virtual pixels of the at least one virtual pixel array in and/or on the one or more virtual pixels of the two or more virtual pixels of the at least one virtual pixel array and/or in and/or on the surface, in particular plane, spanned by the at least one virtual pixel array,
calculating one or more phase images for the one or more virtual pixels of the two or more virtual pixels of the at least one virtual pixel array from a total virtual electromagnetic field consisting of the superposition of the one or more virtual electromagnetic fields in and/or on the one or more virtual pixels of the two or more virtual pixels of the at least one virtual pixel array and/or in and/or on the surface, in particular plane, spanned by the at least one virtual pixel array,
calculating virtual structure profiles for the one or more virtual pixels two or more virtual pixels of the at least one virtual pixel array from the one or more phase images,
forming the virtual structure profiles of the one or more virtual pixels of the two or more pixels of the at least one virtual pixel array in and/or on a substrate as at least one pixel array comprising two or more pixels, wherein one or more pixels of the two or more pixels of the at least one pixel array have one or more structures, for providing the optically variable element.

The object is further achieved by a method for producing a security document, in particular comprising one or more layers, preferably comprising one or more optically variable elements, wherein one or more optically variable elements are applied to the security document and/or to one or more layers of the security document and/or are introduced into the security document and/or into one or more layers of the one or more layers of the security document as a laminating film and/or as an embossing film.

Such an optically variable element is characterized in that it preferably comprises at least one pixel array, wherein the at least one pixel array has two or more pixels comprising structures, wherein in particular each pixel projects, diffracts and/or scatters incident light at predefined solid angles. Here, the size of the predefined solid angles preferably determines the optically detectable appearance of the at least one pixel array. The direction of the emergent light projected, diffracted and/or scattered by the structures can be predefined very precisely.

It is hereby achieved that the optically variable element generates optical movement effects, detectable for an observer and/or sensor, which have excellent detectability as a result of a high brightness, intensity and brilliance of the corresponding appearance.

Advantageous embodiments of the invention are described in the dependent claims.

It is possible that wherein one or more structures of the one or more structures project, diffract and/or scatter incident electromagnetic radiation achromatically at one or more solid angles. Here, the structures are designed in particular such that they do not reflect incident electromagnetic radiation at one or more solid angles, like micromirrors or microfacets for example.

By “solid angle” is usually meant in particular the surface area of a partial surface A of a spherical surface of a sphere, which is preferably divided by the square of the radius R of the sphere. The solid angle is in particular expressed in the dimensionless unit steradian. The whole solid angle preferably corresponds to the surface of the unit sphere or a sphere with a radius of one, thus in particular 4π.

In particular, numerical values for the solid angle at which the structures in the pixels project, diffract and/or scatter light are preferably defined for light incident on the structures perpendicularly, wherein the numerical values of the solid angle preferably indicate the direction of the light cone in relation to the perpendicular z axis.

By “opening angle” is meant in particular the width of the light cone in relation to the straight line in the center of the light cone. The direction of the light cone in relation to an axis, in particular the x or y axis, preferably depends on the optical effect aimed for in each case, wherein the x axis and the y axis are preferably aligned perpendicular to each other, in particular are aligned at an angle of 90° to each other in a plane which is spanned by the x axis and the y axis.

The at least one pixel array is preferably formed as a one-dimensional, two-dimensional or three-dimensional array or arrangement or matrix of pixels, in particular as a superposition of one or more one-dimensional and/or two-dimensional arrays or arrangements or matrices of pixels.

It is possible that the optically variable element and/or the security document comprises one or more layers, wherein in particular the at least one pixel array is arranged on or in at least one layer of the one or more layers, and wherein one or more layers of the one or more layers are preferably selected from: HRI layer (HRI=High Refractive Index, layer with a high refractive index compared with an average refractive index of approximately 1.5), in particular layer comprising HRI and/or LRI varnish layer (LRI=Low Refractive Index, layer with a low refractive index compared with an average refractive index of approximately 1.5), metal layer, interference layer, in particular interference layer sequences, preferably HLH (High-Low-High with respect to the refractive indices of the respective layers) or HLHLH (High-Low-High-Low-High with respect to the refractive indices of the respective layers), further preferably Fabry-Perot three layer system or multilayer system, liquid crystal layer, luminescent layer, in particular fluorescent layer, color layer, in particular glazing ink layer, metal layer in direct contact with a glazing ink layer to generate plasmon resonance effects.

It is further possible that the optically variable element and/or the substrate comprising the at least one pixel array is embedded between two layers, in particular two further layers. One or more layers of the one or more further layers are preferably formed as protective layers, adhesion-promoter layers or adhesion-promoting layers, adhesive layers, barrier layers, decorative layers, reflective layers, conductive layers. The layers can be detachably or non-detachably arranged on a carrier substrate (for example made of polyester, in particular PET).

One or more layers are preferably metallic layers, which are preferably provided in the optically variable element and/or the security document in each case not over the whole surface, but only partially. Here the metallic layers are in particular formed opaque, translucent or semi-transparent. Here the metallic layers preferably comprise different metals, which have different, in particular clearly different, reflection and/or transmission spectra, which can preferably be differentiated by an observer and/or sensor. The metal layers preferably comprise one or more of the metals: aluminum, copper, gold, silver, chromium, tin and/or one or more alloys of these metals. Further, the partially provided metallic layers are preferably gridded and/or designed with locally different layer thicknesses. A grid can in particular be formed regular or fractal or irregular, in particular stochastic, and vary in areas in terms of formation.

In particular, one or more metal layers of the metal layers are here preferably structured in a patterned manner in such a form that they comprise one or more image elements in which the metal of the metal layer is provided and comprise a background area in which the metal of the metal layers is not provided, or vice versa. The image elements here can preferably be formed in the shape of alphanumeric characters, but also of motifs, patterns, graphics and complex representation of objects.

One or more of the layers preferably comprise one or more color layers, in particular glazing inks. These color layers are in particular color layers which are applied by means of a printing method, and which have one or more dyes and/or pigments which are preferably incorporated in a binder matrix. The color layers, in particular inks, can be transparent, clear, partially scattering, translucent, non-transparent and/or opaque.

It is possible that one or more of the layers, in addition to the at least one pixel array, have one or more optically active relief structures, which are preferably introduced in each case into at least one surface of a varnish layer, preferably of a replicated varnish layer. Relief structures of this type are, in particular, diffractive relief structures, such as for example holograms, diffraction gratings, Fresnel freeform surfaces, diffraction gratings with symmetrical or asymmetrical profile shapes and/or zero-order diffraction structures.

Further preferably, the relief structures are isotropic and/or anisotropic scattering matte structures, blazed gratings and/or relief structures with substantially reflective and/or transmissive action, such as for example microlenses, microprisms or micromirrors.

The additional optically active relief structures can in particular either be arranged horizontally adjacent next to the at least one pixel array and/or be arranged vertically above and underneath the at least one pixel array in further layer planes.

By “isotropic intensity distribution” is meant in particular an intensity distribution the radiant power of which is the same over all solid angles.

By “anisotropic intensity distribution” is meant in particular an intensity distribution of which the radiant power at least at one first solid angle differs from that at least at one second solid angle.

It is possible that one or more of the layers have one or more liquid crystal layers, which generate for one thing preferably a reflection and/or transmission of incident light dependent on the polarization of the incident light and for another preferably a wavelength-selective reflection and/or transmission of incident light, depending on the alignment of the liquid crystals.

By “HRI layer” is meant in particular a layer with a high refractive index which for example consists completely or partially of TiO₂ or ZnS, or consists of a vapor-deposited layer of at least one metal oxide, metal sulfide, titanium dioxide and/or other substances and/or combinations of the above substances. In particular, an HRI layer has a layer thickness of from 10 nm to 150 nm. The “HRI layer” can in particular be present over the whole surface or partially.

The one or more structures of the one or more structures and/or the at least one pixel array are preferably introduced into a thin-film structure, in particular into a Fabry-Perot layer structure. The thin-film structure is preferably applied to the one or more structures and/or to the at least one pixel array. In particular, a Fabry-Perot layer structure of this type has, in particular at least in areas, at least one first semi-transparent absorber layer, at least one transparent spacer layer and at least one second semi-transparent absorber layer and/or an opaque reflective layer.

By “thin-film structure” is meant in particular a structure made of thin-film elements which generates a color shift effect dependent on the angle of view, based on an arrangement of layers which has an optical thickness in the region of a half wavelength (λ/2) or a quarter wavelength (λ/4) of incident light or of one or more incident electromagnetic waves. Constructive interference in an interference layer with a refractive index n and a thickness d is preferably calculated by means of the following equation:

2nd cos(θ)=mλ,

wherein θ is the angle between the illumination direction and the viewing direction, λ is the wavelength of the light or of the fields, and m is a whole number. These layers preferably comprise a spacer layer, in particular arranged between an absorption layer and a reflective layer.

By “semi-transparent” is meant in particular a transmissivity in the infrared, visible and/or ultraviolet wavelength range which lies between 10% and 70%, preferably between 10% and 50%, wherein a non-negligible portion of the incident electromagnetic waves, in particular of the incident light, is preferably absorbed.

The first semi-transparent absorber layer preferably has a layer thickness of between 5 nm and 50 nm. The absorber layer preferably features aluminum, silver, copper, tin, nickel, Inconel, titanium and/or chromium. In the case of aluminum and chromium, the first semi-transparent absorber layer preferably has a layer thickness of between 5 nm and 15 nm.

The transparent spacer layer preferably has a layer thickness of between 100 nm and 800 nm, in particular between 300 nm and 600 nm. The spacer layer preferably consists of organic material, in particular of polymer, and/or of inorganic Al₂O₃, SiO₂ and/or MgF₂.

Further preferably, the transparent spacer layer consists of a printed polymer layer, which is applied in particular by means of gravure printing, slot casting or inkjet printing.

By “opaque” is meant in particular that no light in the infrared, visible and/or ultraviolet wavelength range or only a negligible amount of light in the infrared, visible and/or ultraviolet wavelength range, in particular less than 10%, further preferably less than 5%, in particular preferably less than 2%, is transmitted through a substrate, in particular one or more layers of the one or more layers.

It is possible that one or more structures of the one or more structures are allocated to each pixel of the two or more pixels of the at least one pixel array, wherein the one or more structures allocated to a pixel project, diffract and/or scatter incident electromagnetic radiation at one or more predefined solid angles, wherein in particular a direction, preferably a predefined direction, is allocated in each case to the one or more predefined solid angles.

It is further possible that one or more structures of the one or more structures and/or one or more allocated structures of the one or more allocated structures project, diffract and/or scatter at one or more solid angles of the one or more solid angles and/or one or more predefined solid angles of the one or more predefined solid angles, which in particular differ from each other, wherein one or more solid angles of the one or more solid angles and/or predefined solid angles of the one or more predefined solid angles projected onto a sphere, in particular a unit sphere with a unit radius of 1, arranged around a pixel form one or more, in particular identical or different shapes, which are preferably selected in each case from: circular surface, elliptical surface, triangular surface, square surface, rectangular surface, polygonal surface, annular surface.

It is further possible that one or more shapes of the one or more shapes are open or closed and/or consist of one or more partial shapes, wherein in particular at least two partial shapes are combined or superposed with each other.

It is also possible that one or more of the solid angles, detectable by an observer, of the one or more solid angles or predefined solid angles of the one or more predefined solid angles, at which one or more pixels of the two or more pixels of the at least one pixel array project, diffract and/or scatter incident electromagnetic radiation, follow a function, wherein the function is formed in such a way that an observer detects the solid angles or predefined solid angles as bands of brightness moving like waves, preferably sinusoidally moving bands of brightness.

One or more or all solid angles of the one or more solid angles and/or one or more or all predefined solid angles of the one or more predefined solid angles are preferably up to 70°, preferably up to 50°, further preferably up to 40°, in at least one direction. The widening or the opening angle of one or more or all solid angles is preferably at most 20°, further preferably at most 15°, in particular preferably at most 10°.

It is possible to project, to diffract and/or to scatter incident light or incident electromagnetic radiation at and/or onto a solid angle of up to 70°, preferably up to 50°, further preferably up to 40°, in such a way that the visual appearance generated here is detectable for an observer and/or sensor in particular high-gloss-like or semigloss or partially high-gloss-like and partially semigloss, preferably at least as a 3D effect and/or movement effect.

The partial area, in particular appearing semigloss, of the high-gloss-like area with the 3D effect and/or the movement effect is here preferably formed in the shape of a motif, a pattern, a graphic or a complex representation of objects, for example in the shape of an icon, of letters, denomination symbols or the like.

It is further possible that a partial area appearing high-gloss-like is provided in an area appearing semigloss. The combination of a semigloss and high-gloss-like appearance is used in particular in order to make design elements more realistic and thus even easier for laypeople to recognize. For example, it is possible to generate a high-gloss-like 3D effect of a mountain, wherein a semigloss partial area is provided in the area of the mountain peak. This preferably generates the illusion of a snow-covered mountain peak in the high-gloss-like 3D effect. In particular, the combination of semigloss and high-gloss-like appearance visually intensifies the high-gloss-like 3D effect, for example by forming shadows as partial areas appearing semigloss in the high-gloss-like area.

By a sensor is meant in particular at least one human eye and/or at least one two-dimensional detector, preferably at least one CMOS sensor (CMOS=Complementary Metal-Oxide Semiconductor), further preferably at least one CCD sensor (CCD=“Charge-Coupled Device”). In particular, the sensor has a spectral resolution, in particular in the visible electromagnetic spectrum. The sensor is preferably selected or combined from: camera, in particular at least one camera comprising at least one CCD chip, at least one IR camera (IR=infrared), at least one VIS camera (VIS=visual), at least one UV camera (UV=ultraviolet), at least one photomultiplier, at least one spectrometer and/or at least one transition-edge sensor (TES).

It is possible that one or more structures of the one or more structures and/or the structures allocated to one pixel of the two or more pixels of the at least one pixel array are formed in such a way that they provide an item of optically variable information, in particular provide one or more 3D effects and/or movement effects, preferably provide achromatic or monochromatic 3D effects and/or movement effects.

It is also possible that one or more structures of the one or more structures and/or the structures allocated to one pixel of the two or more pixels of the at least one pixel array project, diffract and/or scatter electromagnetic radiation, in particular incident electromagnetic radiation, at a solid angle, in particular a punctiform solid angle, in particular with an opening angle close to 0°.

In particular, one or more structures of the one or more structures and/or one or more pixels of the two or more pixels of the at least one pixel array comprising one or more allocated structures of the one or more allocated structures are allocated to two or more groups of structures and/or two or more groups of pixels, in particular wherein the groups of the two or more groups of structures and/or the groups of the two or more groups of pixels differ from each other.

It is further possible that two or more groups of structures of the two or more groups of structures and/or two or more groups of pixels of the two or more groups of pixels project, diffract and/or scatter electromagnetic radiation, in particular incident electromagnetic radiation, at identical or different solid angles and/or predefined solid angles, in particular punctiform solid angles and/or predefined solid angles, preferably differently shaped solid angles and/or predefined solid angles.

Two or more groups of structures of the two or more groups of structures and/or two or more groups of pixels of the two or more groups of pixels preferably provide an item of optically variable information comprising a 3D effect.

It is also possible that one or more or all of the structures diffractively scatter, deflect and/or project electromagnetic radiation, in particular incident electromagnetic radiation.

In particular, the at least one pixel array has a curvature different from zero in at least one direction at least in areas.

By “curvature” is meant in particular a local deviation of a curve from a straight line. By the curvature of a curve is meant in particular one change in direction per length and/or stretch passed through of a sufficiently short curved piece or curve progression. The curvature of a straight line is equal to zero everywhere. A circle with a radius R has the same curvature everywhere, namely 1/R. In the case of most curves, the curvature changes from curve point to curve point. In particular, the curvature changes continuously from curve point to curve point, with the result that the curves in particular have no kinks and/or points of discontinuity. The curvature of a curve at a point P thus indicates how much the curves in the immediate surroundings of the point P deviates from a straight line. The magnitude of the curvature is called the radius of curvature and this corresponds to the reciprocal of the magnitude of a local radius vector. The radius of curvature is the radius of the circle which only touches the tangential point P and/or represents the best approximation in the local surroundings of the tangential point P. A curve is, for example, the two-dimensional surface and/or a segment of a sphere or of a circular surface or a circular surface.

At least one lateral dimension of one or more pixels of the two or more pixels in the at least one pixel array is preferably between 5 μm and 500 μm, preferably between 10 μm and 300 μm, further preferably between 20 μm and 150 μm.

It is possible that one or more lateral dimensions of one or more pixels of the two or more pixels in the at least one pixel array vary periodically, non-periodically, pseudo-randomly and/or randomly in one or more spatial directions in the at least one pixel array, in particular at least in areas.

By random variation is meant in particular that the distribution on which the variation, in particular the values linked to the variation, is based is preferably a random distribution.

By pseudo-random variation is meant in particular that the distribution on which the variation, in particular the values linked to the variation, is based is preferably a pseudo-random distribution.

By periodic variation is meant in particular that the variation, in particular the values linked to the variation, preferably repeat regularly, in particular at regular spatial and/or time intervals.

By non-periodic variation is meant in particular that the variation, in particular the values linked to the variation, preferably do not repeat regularly, in particular at regular spatial and/or time intervals.

It is further possible that one or more lateral dimensions of one or more pixels of the two or more pixels in the at least one pixel array vary by at most ±70%, preferably by at most ±50%, around an average value in one or more spatial directions in the at least one pixel array, in particular at least in areas.

Preferably, one or more pixels of the two or more pixels in the at least one pixel array are arranged periodically, non-periodically, randomly and/or pseudo-randomly in the at least one pixel array, in particular at least in areas.

It is possible that the pixels in the pixel array form a tiling. By tiling is preferably meant here a gap-free and overlap-free coverage of a plane by uniform or different partial surfaces—here in particular the pixels. The partial surfaces or pixels can in particular have complex outline shapes. Advantageously, the tiling preferably has no periodicity but is, in particular, aperiodic. In one embodiment, the tiling preferably represents a Penrose tiling. In a further embodiment, the tiling is preferably constructed of vector-like two-dimensional, in particular of elongate, pixels. The shape of the elongate pixels can in particular have straight outer edges here at least in pieces, but it can preferably also be present as a freeform. Vector-like two-dimensional pixels of this type preferably have rounded corners and curved edges, wherein further preferably more than 50%, in particular preferably more than 70%, of the corners and edges of the pixel array are rounded or curved respectively. By a rounded corner is preferably meant that the corner has a curve radius of at least 2 μm, preferably at least 5 μm, in particular at least 10 μm. At the same time, the curve radius is to be in particular at most 300 μm, preferably at most 200 μm, in particular at most 100 μm.

Further preferably, one or more pixels of the two or more pixels in the at least one pixel array are arranged along curves or curve segments or circular paths or circular path segments. The outline shapes of the partial surfaces or pixels are preferably designed as curve segments or circular path segments, which in particular make a gap-free sequence possible. If the predefined solid angle allocated to the pixels is changed from one pixel to the next pixel, preferably in steps preferably smaller than 10°, particularly preferably smaller than 5°, in particular preferably smaller than 2°, a virtually continuous movement sequence of an individual point, for example a fine line movement, can thus preferably be provided for an observer. In particular, by combining points visible for an observer to form a pattern, motif, symbol, icon, image, alphanumeric character, freeform, square, circle, rectangle or polygon, a movement sequence along a curve, a curve segment, a circular path or a circular path segment can be achieved.

It is also possible that one or more structures of the one or more structures of the two or more pixels of the at least one pixel array have a grating period or an average spacing of the structure elevations in particular smaller than half, preferably smaller than a third, further preferably smaller than a quarter, of the maximum lateral dimension of the two or more pixels, preferably each of the two or more pixels, of the at least one pixel array.

It is further also possible that one or more structures of the one or more structures have a restricted maximum structure depth, wherein the restricted maximum structure depth in particular is smaller than 15 μm, preferably smaller than 10 μm, further preferably smaller than or equal to 7 μm, even further preferably smaller than or equal to 4 μm, in particular preferably smaller than or equal to 2 μm.

In particular, one or more structures of the one or more structures are formed in such a way that the restricted maximum structure depth of the one or more structures is smaller than or equal to 15 μm, in particular smaller than or equal to 7 μm, preferably smaller than or equal to 2 μm, for more than 50% of the pixels, in particular for more than 70% of the pixels, preferably for more than 90% of the pixels, of the at least one pixel array.

Preferably, one or more structures of the one or more structures are formed in such a way that the restricted maximum structure depth of the one or more structures is smaller than or equal to 15 μm, in particular smaller than or equal to 7 μm, preferably smaller than or equal to 2 μm, for all pixels of the at least one pixel array.

It is also possible that one or more structures of the one or more structures are different from or similar to or the same as or identical to each other.

It is further possible that one or more structures of the one or more structures are formed as achromatically diffracting structures, preferably as blazed gratings, in particular linear blazed gratings, wherein in particular the grating period of the achromatically diffracting structures is larger than 3 μm, preferably larger than 5 μm, and/or wherein in particular more than 70% of the pixels, further preferably more than 90% of the pixels, in particular preferably every pixel, of the two or more pixels of the at least one pixel array comprises at least two grating periods. The grating period is preferably defined together with the grating depth and the alignment of the grating in the x/y plane, at which solid angle the grating present in the respective pixel in particular diffracts incident light achromatically. The alignment of the grating in the x/y plane is preferably also called the azimuthal angle.

In particular, in one or more pixels of the two or more pixels in the at least one pixel array, the achromatically diffracting structures are superposed with further microstructures and/or nanostructures, in particular linear grating structures, preferably crossed grating structures, further preferably subwavelength grating structures.

It is possible that one or more structures of the one or more structures are formed as convexly or concavely acting microlenses and/or partial areas of microlenses, in particular as reflectively acting microlenses and/or partial areas of microlenses, wherein in particular the focal length of the one or more structures is between 0.04 mm and 5 mm, in particular 0.06 mm to 3 mm, preferably 0.1 mm to 2 mm, and/or wherein in particular the focal length in a direction X and/or Y is determined by the equation

$${f}_{X , Y} = \frac{{Δ}_{X , Y} \text{/} 2}{tan ( {ϕ}_{X , Y} \text{/} 2 )}$$

wherein Δ_{X,Y} is preferably the respective lateral dimension of one or more pixels of the two or more pixels of the at least one pixel array in the direction X or in the direction Y, respectively, and ϕ_{X,Y} is the respective solid angle in the direction X or in the direction Y, respectively, at which the one or more structures project, diffract and/or scatter incident electromagnetic radiation.

Further preferably, one or more structures of the one or more structures are formed as cylindrical lenses, wherein in particular a focal length of the one or more structures is infinitely large.

It is further possible that one or more structures of the one or more structures are formed as Fresnel microlens structures, in particular reflectively acting Fresnel microlens structures, wherein in particular the grating lines of the Fresnel microlens structures are formed as curved grating lines and/or have grating lines with varying grating periods, and/or wherein in particular each pixel of the two or more pixels of the at least one pixel array preferably comprises at least two grating periods in at least one spatial direction.

To calculate the microstructure profile for Fresnel microlens structures, precisely one virtual field source is preferably allocated to each pixel in dependence on the allocated solid angle and the lateral dimension of the pixel. The virtual field source in particular emits a virtual spherical wave. The phase image of the virtual electromagnetic field emitted by the virtual field source is preferably calculated in the surface of the pixel and preferably converted linearly into a virtual structure profile, wherein in particular a phase value of 0 corresponds to the minimum structure depth and a phase value of 2*Pi corresponds to the maximum virtual structure depth.

It is also possible that the variants listed above for one or more or all structures of the one or more structures have a binary structure profile or a superposition of one or more binary structure profiles and/or that one or more or all structures of the one or more structures have a binary structure profile or a superposition of one or more binary structure profiles. Binary structures or microstructures of this type in particular have a base surface and one or more structure elements, which preferably in each case have an element surface raised or sunk compared with the base surface and preferably a flank arranged between the element surface and the base surface, wherein in particular the base surface of the microstructure defines a base plane spanned by co-ordinate axes x and y, wherein the element surfaces of the structure elements in each case preferably run substantially parallel to the base plane and wherein the element surfaces of the structure elements and the base surface are preferably spaced apart in a direction running perpendicular to the base plane in the direction of a co-ordinate axis z, in particular with a first distance h, which is preferably chosen such that, in particular by interference of the light reflected on the base surface and the element surfaces in reflected light and/or in particular by interference of the light transmitted through the element surfaces and the base surface in transmitted light, a second color is generated in the one or more first zones. Here, the second color is preferably generated in direct reflection or transmission and in particular the first color, complementary thereto, is generated in the first or in higher orders. For example, the first color can be yellow and the second color can be blue, or the first color can be green and the second color can be red.

It is further possible that the first distance is set to achieve the respectively desired first color. Here, the first distance h is preferably between 150 nm and 1000 nm, further preferably between 200 nm and 600 nm. For effects in transmitted light the first distance is preferably between 300 nm and 4000 nm, further preferably between 400 nm and 2000 nm. Here, the first distance to be set depends in particular on the refractive index of the material which is preferably located between the two planes.

Preferably, a sufficient uniformity of the structure height or of the first distance for achieving as uniform as possible a color impression is advantageous or useful. In an area of surface with a uniform color impression, this first distance preferably varies less than +/−50 nm, further preferably less than +/−20 nm, even further preferably less than +/−10 nm.

Further preferably, several structure elements arranged in steps are provided, wherein in particular all structure elements are arranged substantially parallel to the base surface and the distance from one structure element to the next in each case is preferably either the first distance or a whole-number multiple of the first distance.

Preferably, one or more or all structures of the one or more structures are less preferably formed as micromirrors and/or microprisms which preferably reflect light achromatically, in particular are not formed as micromirrors and/or microprisms which preferably reflect light achromatically.

Further preferably, one or more or all structures of the one or more structures project incident light diffractively.

It is possible that one or more structures of the one or more structures have a quantity of at least 2 elevations, in particular at least 3 elevations, preferably at least 4 elevations, preferably per pixel.

It is further possible that more than 70% of the pixels, in particular more than 90% of the pixels, of the two or more pixels in the at least one pixel array have one or more structures of the one or more structures, which have a quantity of at least 2 elevations, in particular at least 3 elevations, preferably at least 4, preferably per pixel.

It is also possible that one or more structures of the one or more structures, in particular in one or more pixels of the two or more pixels of the at least one pixel array, are formed as chromatic grating structures, in particular as linear gratings, preferably as linear gratings with a sinusoidal profile, and/or nanotext and/or mirror surfaces.

It is further also possible that one or more structures of the one or more structures are formed as subwavelength gratings, in particular as linear subwavelength gratings and/or as moth-eye-like structures, wherein the grating period of the subwavelength gratings, in particular of the linear subwavelength gratings and/or of the moth-eye-like structures is preferably less than 450 nm and/or wherein in particular at least one pixel array of this type provides an optically variable effect detectable for an observer, in particular an additional optically variable effect detectable for an observer, when the optically variable element and/or the at least one pixel array is tilted.

One or more structures of the one or more structures are preferably provided with a metal layer and/or absorb incident electromagnetic radiation, wherein in particular the two or more pixels of the at least one pixel array are detectable in reflection for an observer in dark gray to black.

In particular, one or more structures of the one or more structures have an HRI layer, wherein in particular the two or more pixels of the at least one pixel array are detectable in reflection for an observer in color.

It is possible that one or more structures of the one or more structures project, diffract and/or scatter incident electromagnetic radiation pseudo-randomly or randomly in all spatial directions, wherein the at least one pixel array, in particular one or more pixels, is detectable in reflection for an observer isotropically white, preferably isotropically achromatic.

It is further possible that one or more structures of the one or more structures provide an optically variable effect when the element and/or the at least one pixel array is bent out of shape, wherein in particular a first motif is detectable in an unbent state of the element and/or of the at least one pixel array and a second motif is detectable in a bent state of the element and/or of the at least one pixel array.

For example, when viewed or detected by an observer and/or a sensor, the motifs can assume the shape of one or more letters, portraits, representations of landscapes or buildings, images, barcodes, QR codes, alphanumeric characters, characters, geometric freeforms, squares, triangles, circles, curved lines and/or outlines or the shape of combinations of one or more of the above shapes.

By “freeform” is meant in particular an open or closed two-dimensional surface in a three-dimensional space, which is flat or curved in at least one direction. For example, the surface or a segment of a sphere or the surface or a segment of a torus are closed freeform surfaces. A saddle surface or a curved circular surface are, for example, open freeform surfaces.

It is also possible that the one or more motifs are in each case composed of one or more patterns and/or overlap, wherein the patterns preferably have a geometry and/or shape which are in particular selected or combined in each case from: line, straight line, motif, image, triangle, barcode, QR code, wave, quadrilateral, polygon, curved line, circle, oval, trapezoid, parallelogram, rhombus, cross, sickle, branch structure, star, ellipse, random pattern, pseudo-random pattern, Mandelbrot set, in particular a fractal or the Mandelbrot set, wherein the patterns in particular overlap and/or supplement each other.

Preferred embodiments of the security document are mentioned below.

The security document preferably has one or more optically variable elements in one or more areas, in particular in one or more strip-shaped areas, preferably in one or more thread-shaped areas. Individual optically variable elements can in particular be spaced apart from each other and non-optically variable area can preferably be arranged between the optically variable elements. As an alternative thereto it is possible that individual optically variable elements preferably adjoin each other directly and/or merge into each other and in particular together form an optically variable combination element.

In particular, one or more areas of the one or more areas comprising in each case one or more optically variable elements are formed in the shape of strips and/or patches.

One or more optically variable elements are preferably arranged at least partially overlapping when the security document is viewed along a surface-normal vector spanned by the security document.

Preferred embodiments of the method for producing an optically variable element are mentioned in the following.

It is possible that at least one solid angle is allocated to each pixel of the two or more virtual pixels of the at least one virtual pixel array.

It is possible that each pixel of the two or more pixels of the at least one pixel array comprises one or more structures, in particular microstructures, projecting, diffracting and/or scattering incident light in a targeted manner, wherein structures of this type project, diffract and/or scatter incident light, preferably very efficiently, at one or more predefined solid angles of the one or more predefined solid angles, in particular focused on a point in space, wherein such a point can be, for example, a focal point.

Preferably, for each pixel of the two or more pixels of the at least one pixel array, one or more predefined solid angles of the one or more solid angles are formed such that the microstructures comprised by the pixels project, diffract and/or scatter incident light at these predefined solid angles, wherein one or more effects, in particular one or more static or variable optical effects, are preferably generated.

It is further possible that one or more pixels of the two or more pixels of the at least one pixel array generate a predefined 3D object detectable by an observer or a sensor, wherein different groups of one or more pixels of the two or more pixels of the at least one pixel array comprising one or more structures of the one or more structures, in particular comprising one or more different structures, preferably project, diffract and/or scatter incident light at one or more, in particular different, predefined solid angles of the one or more predefined solid angles, preferably one or more solid angles.

Preferably, one or more predefined solid angles of the one or more predefined solid angles, which are allocated in particular to one or more pixels of the two or more pixels of the at least one pixel array, preferably correlate with a local curvature of a 3D object running in at least one spatial direction. Here, the 3D object recognizable virtually for an observer comprises in particular a plurality of light points, which preferably feature emergent light which, as incident light, has preferably been projected, diffracted and/or scattered by the one or more structures of the one or more structures. One light point is preferably allocated in each case to each pixel of the two or more pixels of the at least one pixel array and/or it generates one light point in each case, wherein one or more light points of the plurality of light points in particular overlap each other, preferably do not overlap each other.

One or more or all structures of the one or more structures are preferably calculated by means of one or more computers, in particular comprising at least one processor and at least one memory, preferably comprising at least one graphics processor and at least one memory. In particular, unlike the computer-generated holograms (CGH) known from the state of the art, the overall effect, for example the virtual 3D object or the achromatic movement effect, is not calculated as a whole or together. According to the invention, the respective structure which achromatically projects, diffracts and/or scatters the light in the predefined direction is preferably calculated separately for each pixel. Each pixel in particular acts substantially independently of the other pixels. The interaction according to the invention of the optical effect of all pixels of the at least one pixel array preferably results in the desired overall effect of the at least one pixel array.

For the calculation of the security and/or decorative element, a solid angle, at which the microstructure is to project, diffract and/or scatter the light, is allocated to each pixel of the at least one pixel array. The respective allocated solid angle preferably correlates directly with the local curvature of the at least one pixel array.

It is possible that the at least one allocated solid angle and/or the at least one area of the at least one allocated solid angle spans the at least one segment, wherein in particular the at least one segment corresponds to at least one segment of a sphere, preferably at least one conical segment, wherein half the opening angle of the at least one segment is smaller than 20°, preferably smaller than 15°, further preferably smaller than 10°.

It is further possible that the virtual field sources, which are arranged in particular in and/or on one or more partial areas of the at least one segment and/or on the at least one area of the at least one allocated solid angle, are arranged periodically and/or pseudo-randomly and/or randomly in at least one direction on one or more partial areas of the one or more partial areas of the at least segment and/or of the at least one area of the at least one allocated solid angle.

It is also possible that the distances between adjacent virtual field sources lie between 0.01 mm and 100 mm, in particular between 0.1 mm and 50 mm, preferably between 0.25 mm and 20 mm, in and/or on one or more partial areas of the one or more partial areas of the at least one segment and/or of the at least one area of the at least one allocated solid angle, and/or that the distances between adjacent virtual field sources in particular lie on average between 0.01 mm and 100 mm, in particular between 0.1 mm and 50 mm, preferably between 0.25 mm and 20 mm, in and/or on one or more partial areas of the one or more partial areas of the at least one segment and/or of the at least one area of the at least one allocated solid angle.

It is further also possible that the arrangement of the virtual field sources, in particular of the virtual point field sources, as a crossed grid, preferably an equidistant crossed grid, is effected in and/or on one or more partial areas of the one or more partial areas of the at least one segment and/or of the at least one area of the at least one allocated solid angle, wherein the distance of adjacent virtual field sources from each other is between 0.01 mm and 100 mm, in particular between 0.1 mm and 50 mm, and/or wherein the angle between two adjacent virtual field sources, in particular relative to the position of the respective one or more virtual pixels of the two or more virtual pixels of the at least one virtual pixel array, is smaller than 1°, preferably smaller than 0.5°.

It is further possible that half the opening angle of a spherical segment and/or of the at least one segment of a sphere is smaller than 20°, in particular smaller than 15°, preferably smaller than 10°, wherein one or more point field sources of the one or more is arranged on the spherical segment and/or the at least one segment of a sphere preferably on a spatially equidistant crossed grid, wherein the angle between two adjacent point field sources, in particular spatially adjacent point field sources, is preferably smaller than 1°, further preferably smaller than 0.5°.

One or more virtual field sources of the one or more virtual field sources preferably have an arrangement in the form of microsymbols, in particular selected from: letter, portrait, image, alphanumeric character, character, geometric freeform, square, triangle, circle, curved line, outline.

The lateral dimensions of the microsymbols further preferably lie between 0.1° and 10°, in particular between 0.2° and 5°.

Preferably, a first group of one or more virtual field sources of the one or more virtual field sources cannot be projected onto a screen from a distance of 0.3 m, in particular of from 0.15 m to 0.45 m, and/or a second group of one or more virtual field sources of the one or more virtual field sources can be projected onto a screen from a distance of 1.0 m, in particular of from 0.8 m to 1.2 m.

In particular preferably, the virtual electromagnetic field which emanates from one or more of the virtual field sources, in particular emanates from all of the virtual field sources, has the same intensity and/or the same intensity distribution over the at least one allocated solid angle and/or over the at least one segment and/or over the at least one area of the at least one allocated solid angle.

By “intensity” is meant in particular the proportion of the total radiant power which is emitted by one or more of the virtual field sources at a predefined solid angle, wherein the radiant power is viewed in particular as the quantity of energy which is transported by an electromagnetic field, in particular by an electromagnetic wave, within a predefined time interval. The radiant power is preferably expressed in the unit Watts.

It is possible that the virtual electromagnetic field which emanates from two or more of the virtual field sources, in particular emanates from all of the virtual field sources, has different intensities and/or different intensity distributions over one or more solid angles, in particular over the whole solid angle, and/or over the at least one area and/or over the at least one segment of the at least one allocated solid angle.

It is further possible that the virtual electromagnetic field which emanates from one or more of the virtual field sources, in particular emanates from all of the virtual field sources, has an intensity distribution over the at least one allocated solid angle and/or over the at least one segment and/or over the at least one area of the at least one allocated solid angle which has a Gaussian or super-Gaussian distribution.

It is also possible that the virtual electromagnetic field which emanates from two or more of the virtual field sources, in particular emanates from all of the virtual field sources, has different intensities and/or different intensity distributions over the at least one allocated solid angle and/or over the at least one segment and/or over the at least one area of the at least one allocated solid angle.

It is further also possible that the virtual electromagnetic field which emanates from one or more of the virtual field sources, in particular emanates from all of the virtual field sources, has an isotropic or an anisotropic intensity distribution over the at least one allocated solid angle and/or over the at least one area and/or over the at least one segment of the at least one allocated solid angle.

In particular, one or more virtual field sources of the one or more virtual field sources, in particular all of the virtual field sources, form virtual point field sources, wherein the virtual point field sources preferably emit virtual spherical waves.

By “spherical wave” or “virtual spherical wave” is meant a wave which propagates from a field source, in particular a virtual field source, at the whole solid angle, in particular at a solid angle of 4π, in concentric wavefronts, wherein the field source is preferably understood to be a punctiform source of the spherical wave.

It is possible that the one or more virtual field sources, in particular one or more virtual point field sources, in each case emit one or more virtual fields of the one or more virtual fields as virtual spherical waves from a distance of 1 m from in particular one or more pixels of the two or more pixels of the at least one pixel array. Here, an equally bright surface and/or a surface of homogeneous intensity is preferably generated at a distance of 1 m from the one or more pixels, wherein the size and/or shape of the surface is determined by the at least one allocated solid angle and/or over the at least one segment and/or by the at least one area of the at least one allocated solid angle.

It is further possible that in particular the resulting at least one pixel array and/or the resulting optically variable element, at a distance of 30 cm, preferably at a typical and/or normal reading distance or viewing distance of a human observer and/or sensor, is preferably not detected visually as an image, but further preferably as scattering. At a distance of 1 m, the surface, in particular the equally bright surface and/or the surface of homogeneous intensity, in particular becomes visible.

It is also possible to deactivate individual virtual point field sources, wherein the deactivated point field sources are preferably detectable for an observer and/or sensor at a distance of 1 m as one or more motifs, in particular as text, on the equally bright surface and/or in the surface of homogeneous intensity. In particular, a deactivated field source and/or point field source does not emit any virtual electromagnetic fields. An observer and/or a sensor is in particular not able to detect the absence of individual light points caused by the deactivated point field sources at a distance of 30 cm, wherein information can in this way advantageously be hidden in the at least one pixel array and/or the optically variable element.

It is further also possible to arrange the virtual point field sources in the at least one allocated solid angle and/or in the at least one area of the at least one allocated solid angle in such a way that a motif, in particular an image, is preferably generated by one or more pixels of the two or more pixels of the at least one pixel array, and/or can preferably be detected by an observer and/or a sensor, at a distance of 1 m.

The virtual electromagnetic field Uᵢ emanating from an i-th virtual point field source at the location (xᵢ, yᵢ, zᵢ) of at least one coordinate (xₕ, yₕ, zₕ), in particular a coordinate (xₕ, yₕ, zₕ=0)=(xₕ, yₕ), in and/or on one or more virtual pixels of the two or more virtual pixels of the at least one virtual pixel array and/or in and/or on the surface, in particular plane, spanned by the at least one virtual pixel array, is preferably calculated by means of the equation

$${U}_{i} ( {x}_{h} , {y}_{h} ) = \frac{exp ( ikr )}{r} , r = \sqrt{{( {x}_{h} - {x}_{i} )}^{2} + {( {y}_{h} - {y}_{i} )}^{2} + {z}_{i}^{2}} , .$$

It is possible that the virtual electromagnetic field Uᵢ comprises one or more wavelengths, which lie in particular in the visible spectral range of from 380 nm to 780 nm, preferably from 430 nm to 690 nm, preferably in one or more portions of an infrared, visible or visual, and/or ultraviolet spectral range, wherein one or more in each case adjacent wavelengths of the one or more wavelengths, preferably in the visible spectral range, are spaced apart from each other, preferably equidistantly.

It is further possible that the one or more wavelengths, in particular one or more wavelengths of the one or more virtual electromagnetic waves, preferably one or more wavelengths of the incident light or of the incident electromagnetic radiation, are selected from the infrared and/or visible and/or ultraviolet spectrum, in particular from the electromagnetic spectrum.

By an infrared spectrum is preferably meant one or more portions of the infrared range of the electromagnetic spectrum, wherein the infrared spectrum is selected in particular from one or more portions of the wavelength range of from 780 nm to 1400 nm.

By a visible spectrum is preferably meant one or more portions of the visible range of the electromagnetic spectrum, wherein the visible spectrum is selected in particular from one or more portions of the wavelength range of from 380 nm to 780 nm. In particular, a visible spectrum is detectable for the naked human eye.

By an ultraviolet spectrum is preferably meant one or more portions of the ultraviolet range of the electromagnetic spectrum, wherein the ultraviolet spectrum is selected in particular from one or more portions of the wavelength range of from 250 nm to 380 nm.

A calculation of one or more virtual structure profiles of the one or more virtual structure profiles of one or more or all virtual pixels of the two or more virtual pixels of the at least one virtual pixel array for one or more wavelengths, in particular for several wavelengths in the visible spectral range between 380 nm and 780 nm, preferably between 430 nm and 690 nm, is possible, wherein the one or more wavelengths are preferably calculated with an equally high efficiency. The wavelength-dependent partial fields Uᵢ are in particular weighted with the efficiency and totaled.

The one or more virtual structure profiles are preferably calculated for at least five wavelengths distributed over the visible spectral range, wherein the resulting structures formed project, diffract and/or scatter incident light achromatically and advantageously without disruptive diffractive color effects at least at one predefined solid angle.

The at least five wavelengths are preferably chosen distributed evenly over the visible spectral range. In an alternative embodiment, at least six wavelengths on the flanks of the sensitivity curve of the human photoreceptors are preferably chosen and preferably in each case two wavelengths one on each flank of each photoreceptor. For the blue receptor the two wavelengths are preferably chosen in the range 420 nm to 460 nm, and/or for the green receptor the two wavelengths are preferably chosen in the range 470 nm to 530 nm, and/or for the red receptor the two wavelengths are preferably chosen in the range 560 nm to 630 nm.

In particular, the at least one wavelength is contained in the wave vector, preferably the wave vector k=2×π/λ.

It is further possible that the virtual electromagnetic field Uᵢ comprises one or more wavelengths, which lie in particular in the infrared, visible and/or ultraviolet spectral range, wherein one or more in each case adjacent wavelengths of the one or more wavelengths, preferably in the infrared, visible and/or ultraviolet spectral range, are spaced apart from each other, preferably equidistantly.

The total virtual electromagnetic field Uₚ in and/or on one or more virtual pixels of the two or more virtual pixels of the at least one virtual pixel array and/or in and/or on the surface, in particular plane, spanned by the at least one virtual pixel array is preferably calculated by means of the equation

$${U}_{p} ( {x}_{p} , {y}_{p} ) = {U}_{r}^{*} ( {x}_{p} , {y}_{p} ) {\sum }_{i = 1}^{{N}_{p}} {U}_{i} ( {x}_{p} , {y}_{p} ) ,$$

wherein in particular the virtual electromagnetic fields Uᵢ emanating from i=1, . . . , Nₚ virtual point field sources at least at one coordinate (xₚ, yₚ, zₚ=0)=(xₚ, yₚ) and/or in particular the optional reference wave Uᵣ*, preferably the at least one optional reference wave Uᵣ*, are calculated at least at one point or, for the parameters (xₚ, yₚ), in and/or on the one or more virtual pixels of the two or more virtual pixels of the at least one virtual pixel array and/or in and/or on the surface, in particular plane, spanned by the at least one virtual pixel array.

It is possible that the at least one optional reference wave is chosen such that for one or more virtual field sources of the one or more field sources the corresponding intensities and phases are ideally compensated for. Here, the at least one optional reference wave can, for example, simulate the incident electromagnetic radiation from a spotlight at a distance of 1.5 m from the at least one pixel array and/or the optically variable element. In particular, the phase of the at least one optional reference wave is contained in one or more phase images of the one or more phase images for calculating the virtual structure profiles for the one or more virtual pixels of the two or more virtual pixels of the at least one virtual pixel array.

In particular, one or more phase images of the one or more phase images are converted into a virtual structure profile, preferably converted linearly into a virtual structure profile, wherein a phase value of 0 corresponds to the minimum depth and a phase value of 27 corresponds to the maximum depth of the formed one or more structures of one or more or all pixels of the two or more pixels of the at least one pixel array.

It is further possible to convert one or more or all phase images of the one or more phase images into a binary virtual structure profile, wherein the phase values preferably between 0 and π correspond to the minimum depth and phase values preferably between π and 2π correspond to the maximum depth of the formed one or more structures of one or more or all pixels of the two or more pixels of the at least one pixel array. Furthermore, an allocation of the phase values to a virtual structure profile with more than two steps, in particular with n steps, is possible.

The conversion of the phase images is preferably carried out for each pixel of the two or more pixels of the at least one pixel array, wherein in particular in each case one or more phase images of the one or more phase images are allocated to each pixel of the two or more pixels of the at least one pixel array.

It is also possible that the virtual structure profile of one or more virtual pixels of the two or more virtual pixels of the at least one virtual pixel array is formed by means of laser exposure and development on a plate coated with photoresist or by means of electron-beam lithography as the one or more structures of one or more pixels of the two or more pixels of the at least one pixel array. A further production method is in particular laser ablation, for example directly in polymer or glass or metal substrates, in particular in polycarbonates (PC) or polymethyl methacrylates (PMMA) or copper.

It is further also possible that one or more structures comprised or formed in one or more pixels of the two or more pixels of the at least one pixel array have an optical depth, in particular an optical depth in air or polymer, of half the average wavelength of the virtual electromagnetic field and/or of the total virtual electromagnetic field.

By optical depth is meant in particular a dimensionless measure for the degree to which a physical medium and/or substance slows electromagnetic waves or electromagnetic radiation.

One or more structures of the one or more structures preferably have an optical depth corresponding to half the average wavelength of the calculated virtual electromagnetic fields. The fields are preferably calculated for a whole-number multiple of the viewing wavelength and also implemented, e.g. calculated for 5×550 nm=2750 nm and implemented 1375 nm deep. This has the advantage in particular that the structures have a less diffractive action and thus appear more achromatic.

In particular, the structures differ from conventional holograms by the depth, preferably optical depth, increased in this way, wherein here the structures in particular do not have a purely deflective and/or diffractive action. Further, the structures are small and flat such that in particular they do not have a purely refractive action and in the process preferably differ from micromirrors. The small structure depth compared with micromirrors preferably reduces the necessary thickness of the security features and additionally in particular allows a simpler manufacture in mass production. The structures are preferably so-called “multi-order diffractive elements” which have properties of conventional holograms and of conventional micromirrors.

Preferred embodiments of the method for producing a security document, in particular comprising one or more optically variable elements, are mentioned in the following.

The structure profiles formed are preferably introduced into or applied to an opaque or transparent substrate, in particular into or to opaque or transparent paper or polymer documents or into or to opaque or transparent paper or polymer banknotes.

In particular, the structure profiles are introduced, by means of the methods of electroplating, recombination and roll-to-roll replication, into a layer on a film, in particular into an at least one replication layer and/or into a metal layer and/or into a transparent high-refractive or low-refractive layer. In the case of the replication layer, this can in particular subsequently be provided with a metal layer and/or a transparent high-refractive or low-refractive layer, with the result that the metal layer and/or the transparent high-refractive or low-refractive layer preferably follows the structure profile of the replication layer.

By a “high-refractive layer” is meant in particular a layer with a high refractive index, in particular with a refractive index greater than 1.5, preferably greater than 1.7.

By “low-refractive layer” is meant in particular a layer with a low refractive index, in particular with a refractive index smaller than 1.5, preferably smaller than 1.4.

By refractive index or refractive number or optical density is preferably meant an in particular dimensionless optical material property which in particular indicates by what factor the wavelength and/or the phase velocity of an electromagnetic wave or electromagnetic radiation is smaller in a material than in a vacuum. At a transition of an electromagnetic wave between materials and/or substances with different refractive indices, the electromagnetic wave is refracted and/or scattered, in particular reflected.

In particular, the film has an HRI layer (HRI=High Refractive Index; HRI layer=high refractive layer). A high-refractive layer of this type is formed in particular of ZnS or TiO₂. Alternatively or additionally, the film preferably has a metal layer, in particular a metal layer selected from the following metals: aluminum, copper, gold, silver, chromium, tin and/or one or more alloys of these metals. The HRI layer and/or metal layer is preferably applied to the film on and/or in one or more structure profiles of the one or more structure profiles after a roll-to-roll replication step.

It is possible that one or more structures of the one or more structures and/or the at least one pixel array are introduced into or applied to at least one window area, in particular into or to at least one window area of an ID1 card, or into or to a transparent substrate, in particular into or to a transparent polymer banknote, whereby the one or more structures and/or the at least one pixel array is detectable at least from the front and rear side and/or when viewed in transmitted light. The at least one window area in particular has a through-hole in the substrate and/or a transparent area, not broken through, of the substrate.

By “transparent” is meant in particular a transmissivity in the infrared, visible and/or ultraviolet wavelength range which lies between 70% and 100%, preferably between 80% and 95%, wherein a negligible portion of the incident electromagnetic radiation, in particular of the incident light, is preferably absorbed.

By an “ID1 card” is meant in particular a security document or a card with dimensions of 85.6 mm×53.99 mm, wherein the dimensions of the security document or of the card correspond to the ID1 format.

In particular, one or more optically variable elements are introduced into and/or applied to packaging of all types, preferably for decorative purposes and/or for identification purposes.

It is possible that one or more optically variable elements are introduced into and/or applied to a substrate and/or one or more further layers, in particular with registration accuracy or register accuracy in particular relative to each other and/or to further security elements and/or further decorative elements and/or to the edges of the substrate and/or the one or more layers.

By register or registration, or register accuracy or registration accuracy or positional accuracy, is meant in particular a positional accuracy of two or more elements and/or layers relative to each other. The register accuracy is preferably to range within a predefined tolerance and preferably be as high as possible. At the same time, the register accuracy of several elements and/or layers relative to each other is further preferably an important feature in order in particular to increase the process reliability. The positionally accurate positioning can be effected in particular by means of sensorially, preferably optically detectable registration marks or the position marks. These registration marks or position marks can either represent special separate elements or areas or layers or themselves be part of the elements or areas or layers to be positioned.

It is possible that the substrate is provided, before or after the introduction of the virtual structure profiles, with a glazing ink layer which has the function of a color filter. The provision with a glazing ink layer can be effected before or after the introduction of the virtual structure profiles and application of a metal layer and/or of a transparent high- or low-refractive layer. For example, the glazing ink layer changes the achromatic white appearance of the at least one pixel array and/or optically variable element for an observer and/or sensor into a monochromatic appearance.

The invention is explained in the following with reference to several embodiment examples utilizing the attached drawings by way of example. There are shown in:

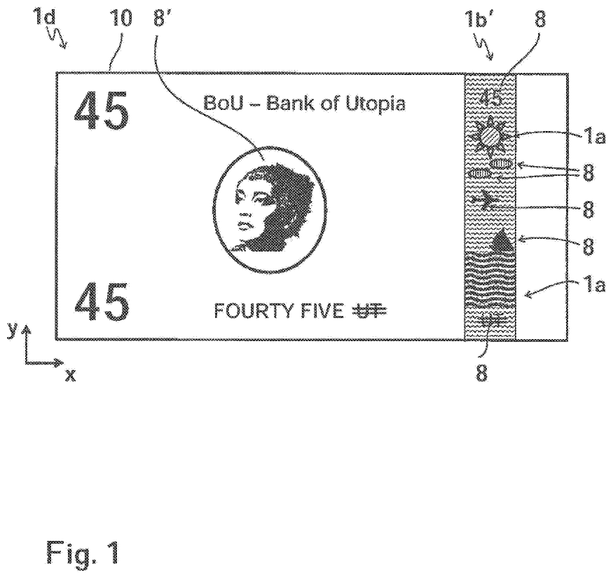

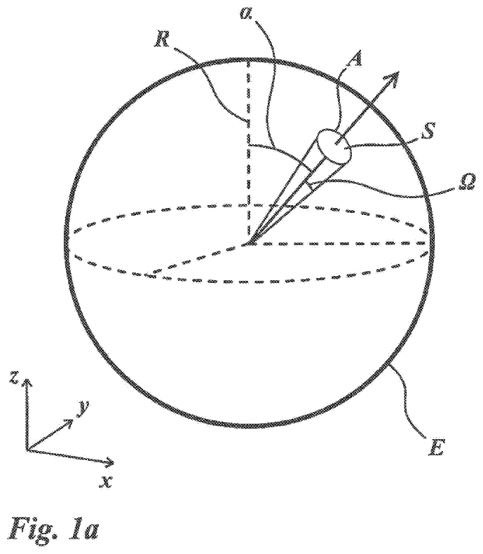

FIG. 1 shows a schematic representation of a security document.

FIG. 1a shows a schematic representation of a security document.

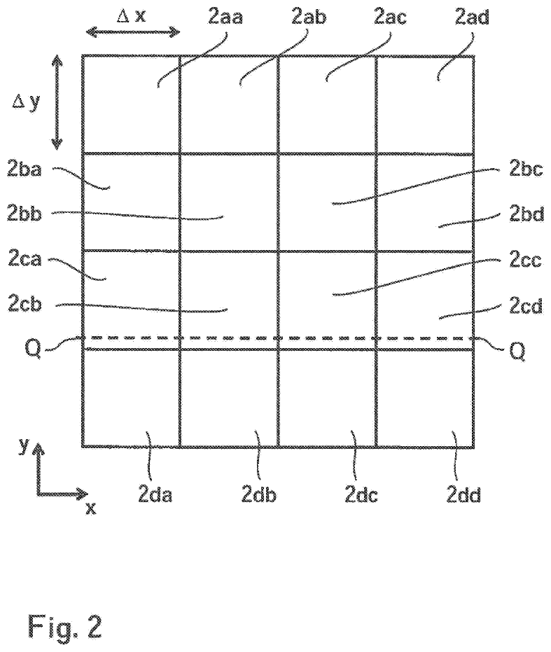

FIG. 2 shows a schematic representation of an optically variable element.

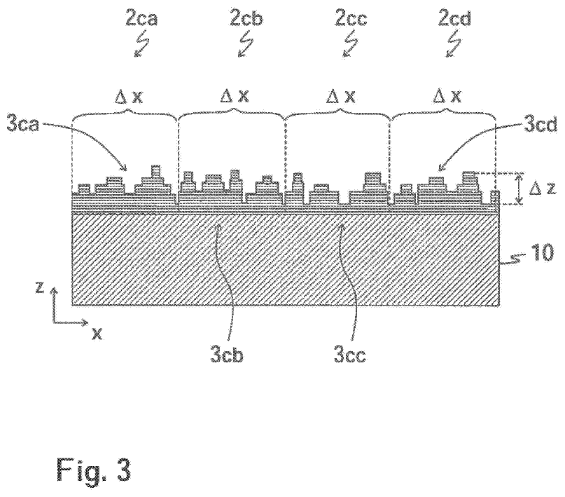

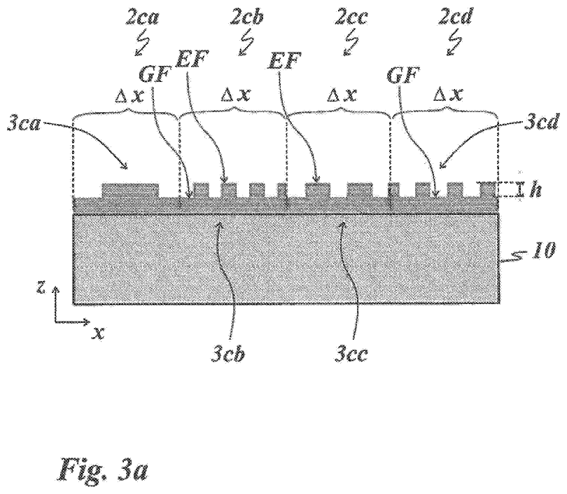

FIG. 3 shows a schematic cross section of an optically variable element.

FIG. 3a shows a schematic cross section of an optically variable element.

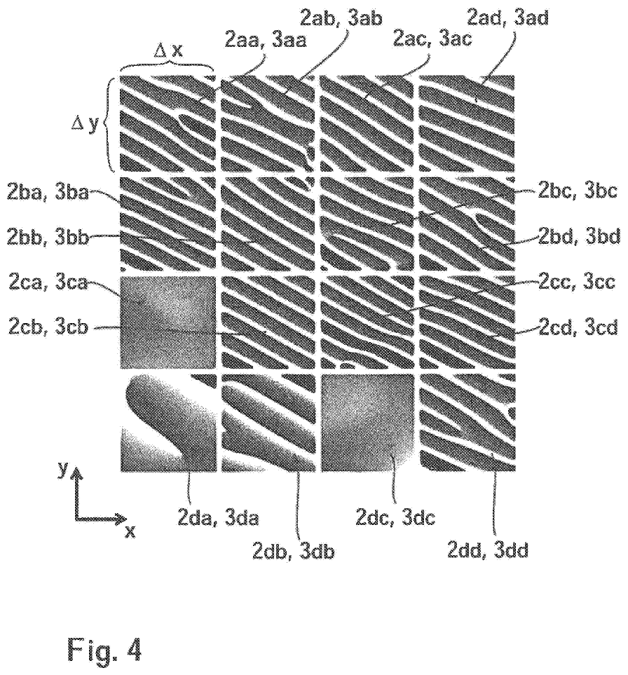

FIG. 4 shows a schematic representation of an optically variable element.

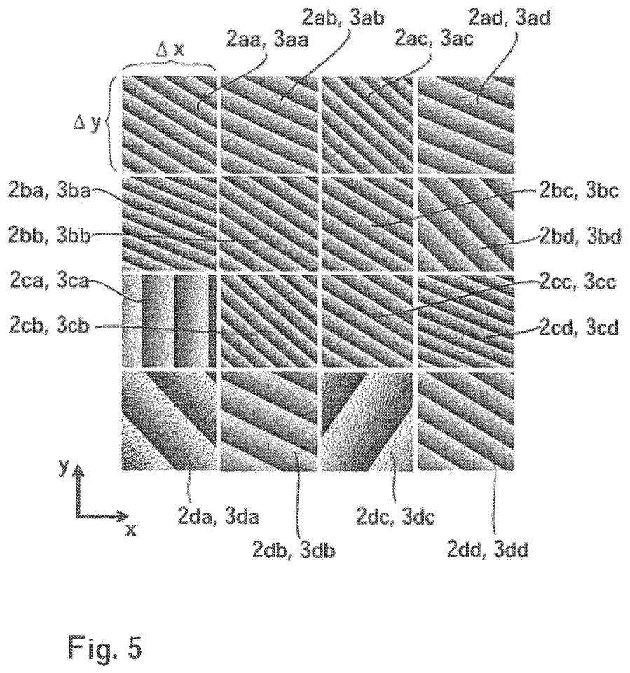

FIG. 5 shows a schematic representation of an optically variable element.

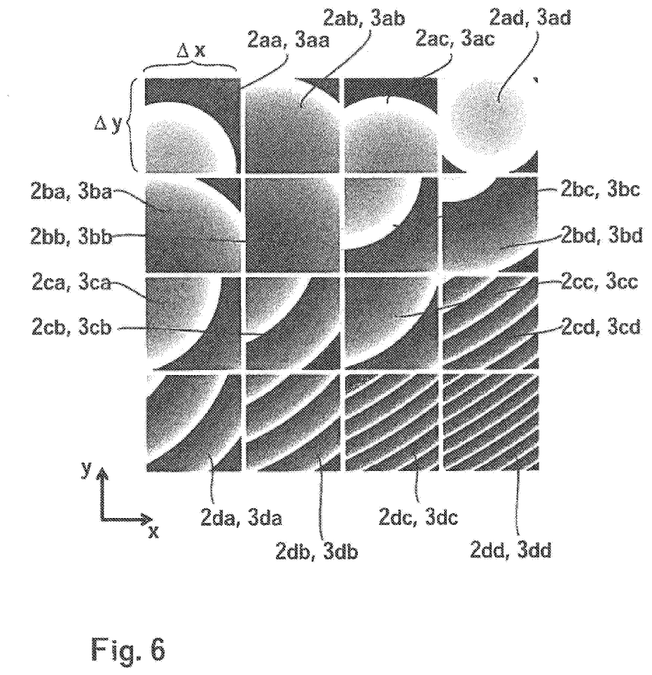

FIG. 6 shows a schematic representation of an optically variable element.

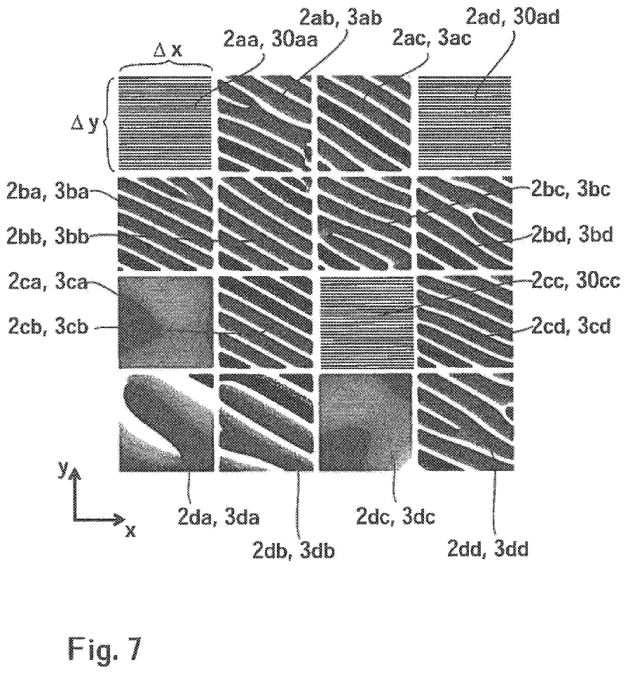

FIG. 7 shows a schematic representation of an optically variable element.

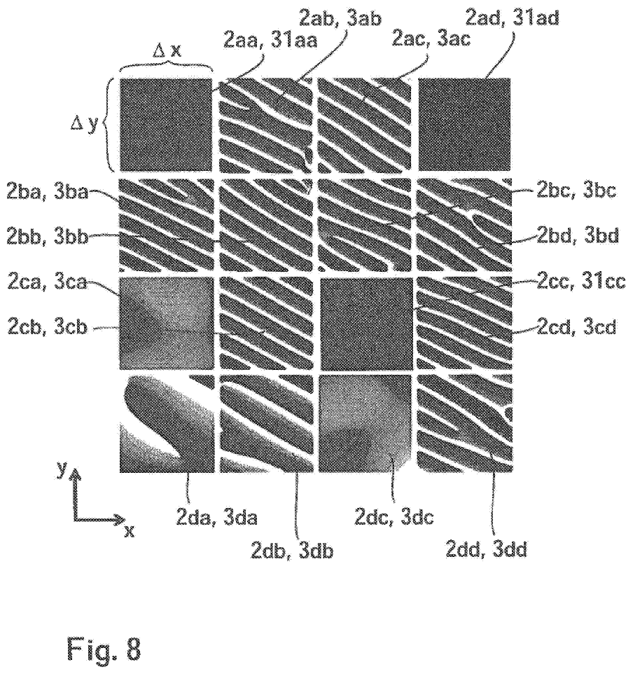

FIG. 8 shows a schematic representation of an optically variable element.

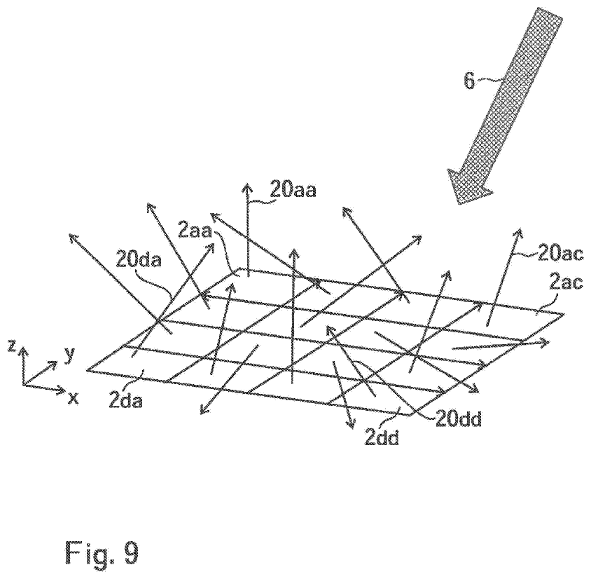

FIG. 9 shows a schematic representation of a pixel array.

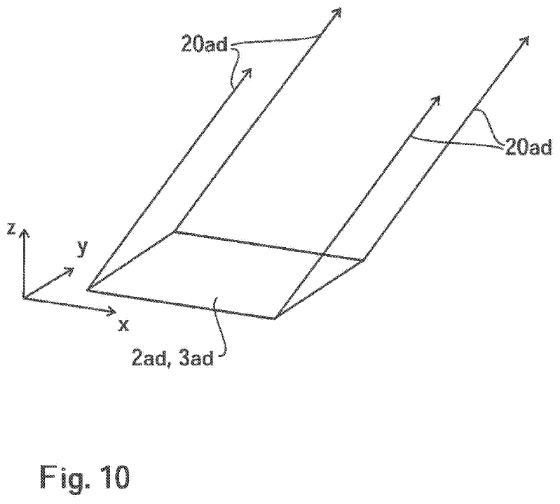

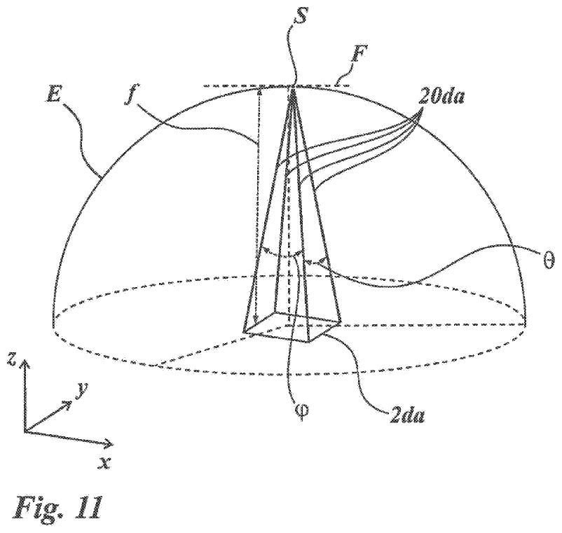

FIG. 10 shows a schematic representation of a pixel.

FIG. 11 shows a schematic representation of a pixel.

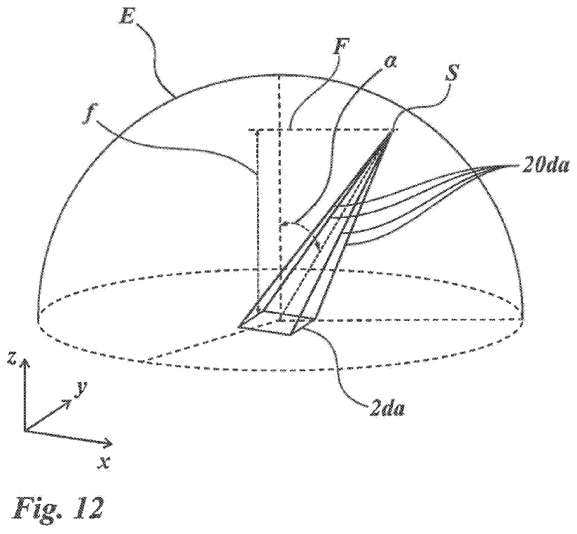

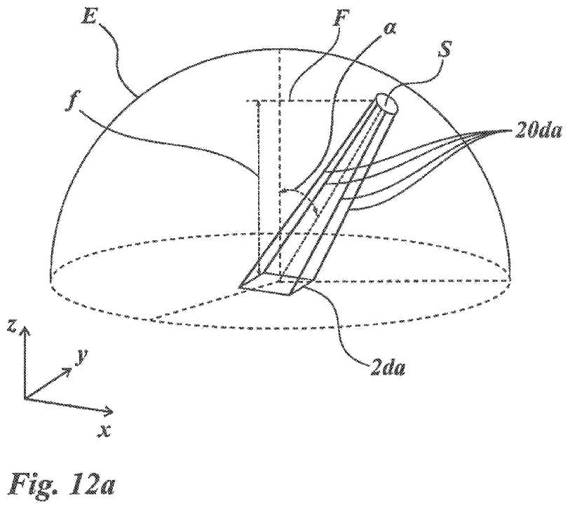

FIG. 12 shows a schematic representation of a pixel.

FIG. 12a shows a schematic representation of a pixel.

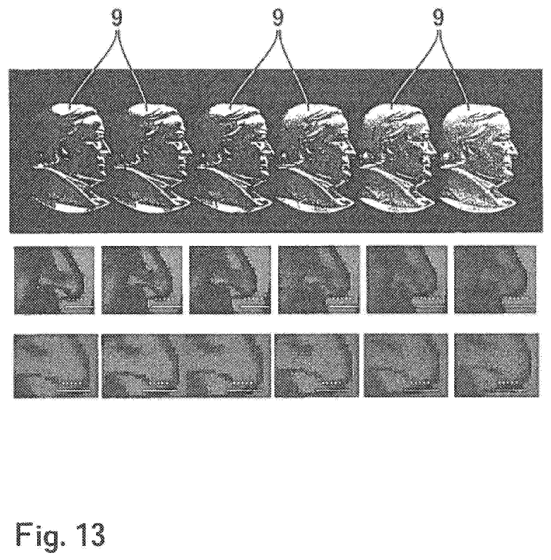

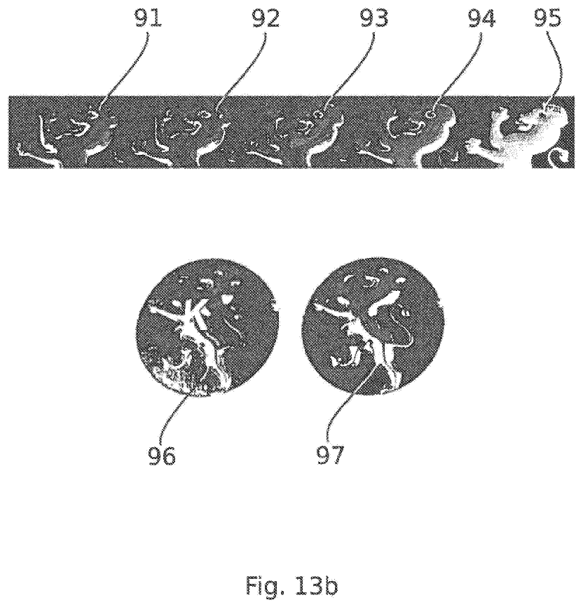

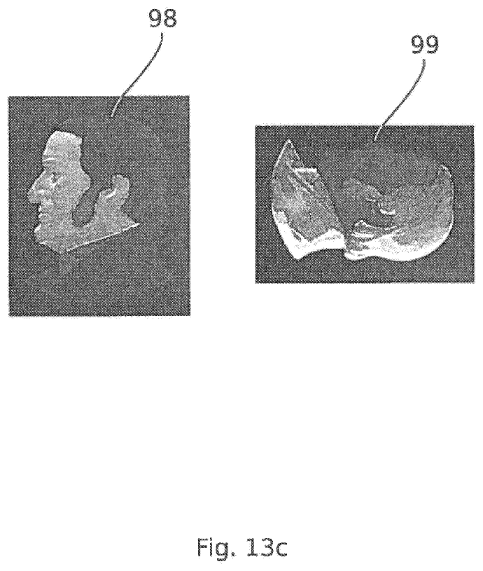

FIG. 13 shows a photo as well as microscope images of an optically variable element.

FIG. 13b shows a schematic representation of an optically variable element.

FIG. 13c shows a schematic representation of an optically variable element.

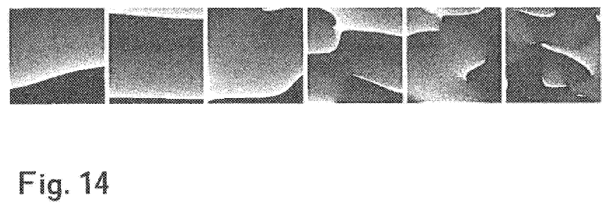

FIG. 14 shows a schematic representation of an optically variable element.

FIG. 15 shows a schematic representation of an optically variable element.

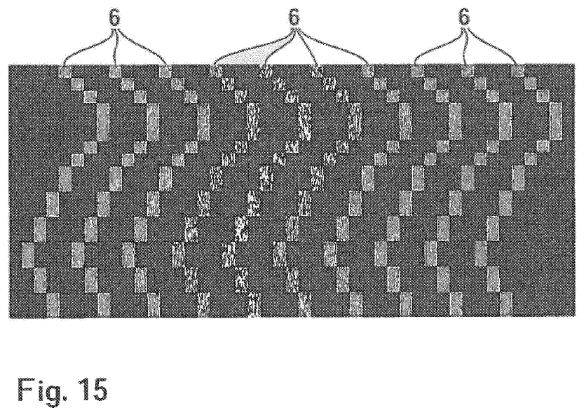

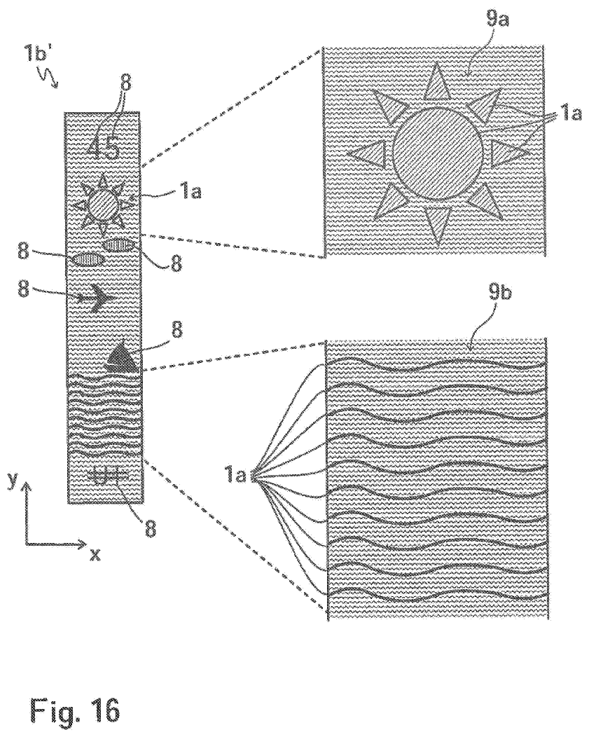

FIG. 16 shows a schematic representation of an optically variable element.

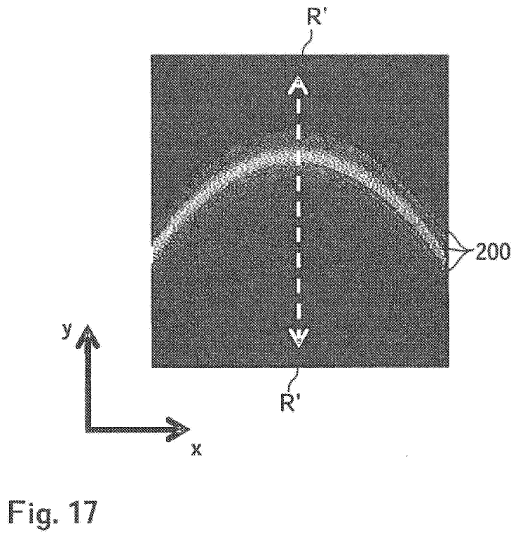

FIG. 17 shows a photo of an optically variable element.

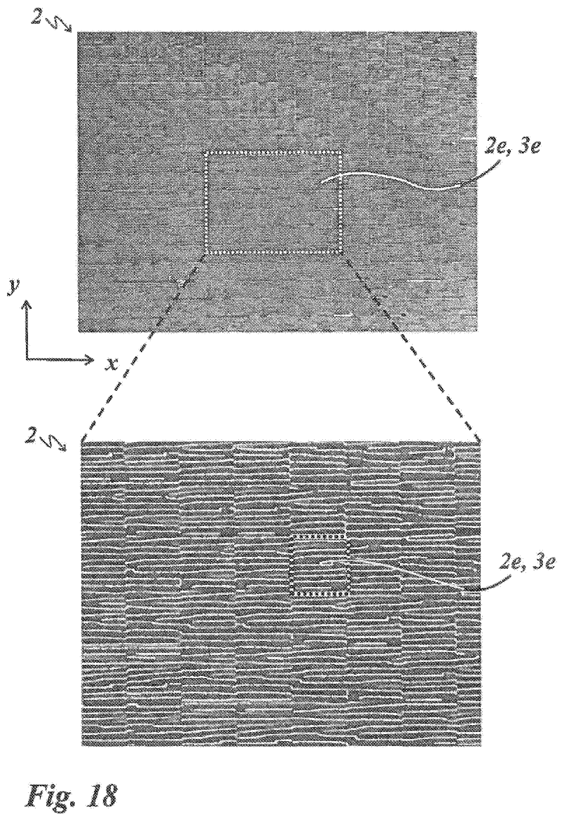

FIG. 18 shows microscope images of a pixel array.

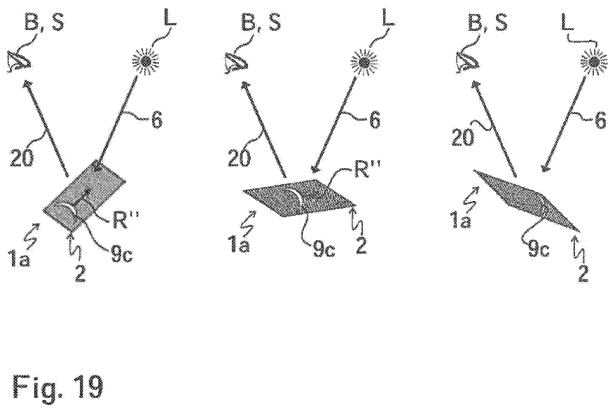

FIG. 19 shows a schematic representation of an optically variable element.

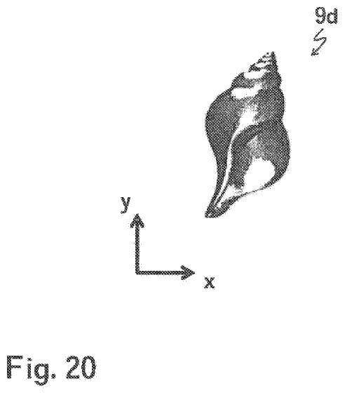

FIG. 20 shows a photo of an optically variable element.

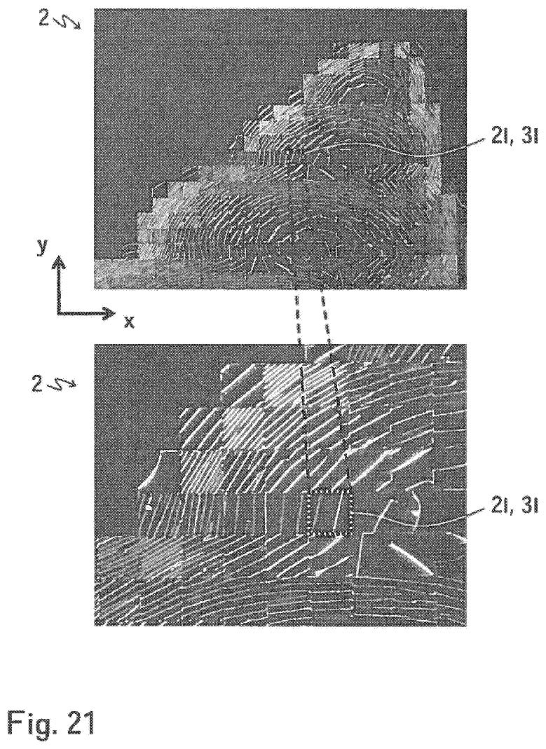

FIG. 21 shows microscope images of a pixel array.

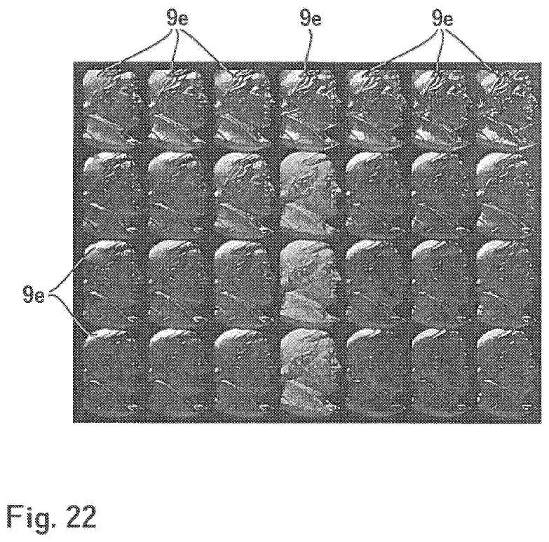

FIG. 22 shows a photo of an optically variable element.

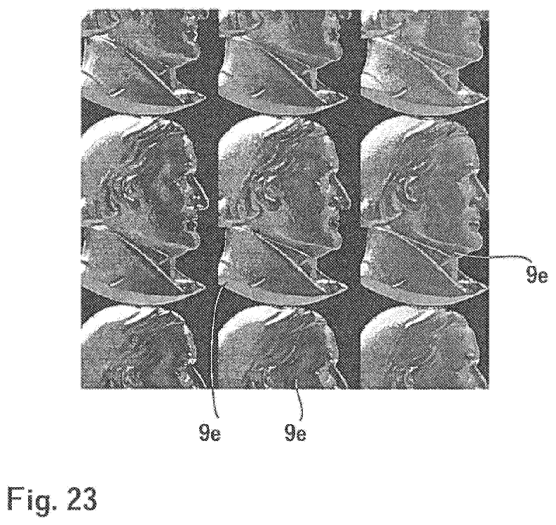

FIG. 23 shows a photo of an optically variable element.

FIG. 1 shows a security document 1d, in particular a banknote, comprising a substrate 10 in top view, which has a strip-shaped security element 1b′, wherein movement effects and/or 3D elements visually virtually jumping out in the viewing direction and/or jumping back from the viewing direction are detectable for an observer when the security element 1b′ is viewed in reflected light and/or transmitted light. Optical effects of this type are preferably dependent on the tilt angle and/or the viewing angle relative to the plane spanned by the substrate 10.

It is possible that the security document 1d, in or outside the strip-shaped area 1b′, has one or more further optically variable elements and/or optically invariable security elements, which in particular can partially or completely overlap with the security element 1b′.

It is further possible that, in and/or on the security document 1d, one or more further areas comprising in each case one or more further optically variable elements are formed in the shape of strips and/or patches.

It is also possible that one or more optically variable elements are arranged at least partially overlapping when the security document 1d is viewed, in particular by an observer and/or a sensor, along a surface-normal vector spanned by the security document 1d.

The strip-shaped security element 1b further comprises two optically variable elements 1a, each of which in particular has at least one pixel array comprising two or more pixels. An optically variable element of the two optically variable elements is formed in the shape of a motif comprising the sun and a further optically variable element of the two optically variable elements is formed in the shape of a motif comprising a plurality of ten wavy lines or thin strips spaced apart from each other. Motifs of this type are selected in particular from: patterns, letters, portraits, images, alphanumeric characters, characters, representations of landscapes, representations of buildings, geometric freeforms, squares, triangles, circles, curved lines and/or outlines.

The strip-shaped security element 1b′ further comprises several security elements 8, which are designed as the number sequence “45”, two cloud-like motifs, a motif in the shape of an aircraft, a motif in the shape of a sailing ship and a letter sequence “UT” with two horizontal lines through it. The number sequence “45” and the letter sequence “UT” with two horizontal lines through it can be realized, for example, as demetalized areas and the two cloud-like motifs, the motif in the shape of an aircraft and the motif in the shape of a sailing ship can be realized in particular with vividly colored, diffractive structures.

Furthermore, the security document 1d comprises a security element 8′, which has a motif comprising a portrait. Here it is possible that the optically variable structures 8′ are formed as surfaces that light up diffractively when illuminated and/or that the optical impression of the portrait 8′, which in particular is formed as a Fresnel freeform surface, is detectable for an observer and/or a sensor in reflected light and/or transmitted light. Alternatively, the security element 8′ can in particular also be an intaglio or offset print.

The strip-shaped security element 1b′ preferably comprises, in addition to the optically variable elements 1a which each have a pixel array, at least one height profile of at least one further optically variable structure, in particular selected from: a diffractive relief structure, in particular a diffraction grating, a Fresnel freeform lens, a zero-order diffraction structure, a blazed grating, a micromirror structure, an isotropic or anisotropic matte structure and/or a microlens structure.

It is also possible that one or more or all of the structures diffractively scatter, deflect and/or project electromagnetic radiation, in particular incident electromagnetic radiation.

In particular, the at least one pixel array has a curvature different from zero in at least one direction at least in areas.

The document body of the security document 1d comprises in particular one or more layers, wherein the substrate 10 is preferably a paper substrate and/or a plastic substrate or a hybrid substrate, consisting of a combination of paper and plastic.

It is further possible that the strip-shaped security element 1b′ has one or more layers and in particular has a carrier substrate (preferably made of polyester, in particular PET), which is detachable or non-detachable, and/or one or more polymer varnish layers, in particular one or more replication layers, in which the height profiles of at least one further optically variable structure can be replicated.

It is also possible that the strip-shaped security element 1b′ comprises one or more protective layers and/or one or more decorative layers and/or one or more adhesive layers or adhesion-promoting layers or adhesion-promoter layers and/or one or more barrier layers and/or one or more further security features.

One or more decorative layers of the decorative layers preferably have one or more metallic and/or HRI layers, which are preferably provided in the optically variable element and/or the security document in each case not over the whole surface but only partially. Here the metallic layers are in particular formed opaque, translucent or semi-transparent. Here the metallic layers preferably comprise different metals, which have different, in particular clearly different, reflection, absorption and/or transmission spectra, in particular reflectance, absorbance and/or transmittance, which can preferably be differentiated by an observer and/or sensor. The metal layers preferably comprise one or more of the metals: aluminum, copper, gold, silver, chromium, tin and/or one or more alloys of these metals. Further, the partially provided metallic layers are gridded and/or designed with locally different layer thicknesses.

By reflectance is meant in particular the relationship between the intensity of the reflected portion of an electromagnetic wave or electromagnetic radiation and the intensity of the incident portion of the electromagnetic wave or electromagnetic radiation, wherein the intensity is in particular a measure of the energy transported by the electromagnetic wave or electromagnetic radiation.

By absorbance or absorption coefficient is meant in particular a measure of the decrease in the intensity of electromagnetic waves or electromagnetic radiation when penetrating through a substance and/or through a material, wherein the dimension of the absorbance and/or of the absorption coefficient is, in particular, 1/unit of length, preferably 1/measure of length. For example, an opaque layer has a larger absorption coefficient for visible radiation than air.

By transmittance and/or optical density is preferably meant an in particular dimensionless measure which indicates how much the intensity of an electromagnetic wave or electromagnetic radiation decreases when it penetrates through a substance and/or a material.

In particular, one or more metal layers of the metal layers are here preferably structured in a patterned manner in such a form that they comprise one or more image elements, in which the metal of the metal layer is provided, and comprise a background area, in which the metal of the metal layers is not provided. The image elements here can preferably be formed in the shape of alphanumeric characters, but also of graphics and complex representation of objects. The image elements can in particular also be formed as a gridded, high-resolution grayscale image, for example a portrait, a building, a landscape or an animal. The grid can in particular be formed regular or fractal or irregular, in particular stochastic, and preferably vary in areas in terms of formation.

One or more decorative layers of the decorative layers preferably further comprise in particular one or more color layers, in particular glazing inks. These color layers are in particular color layers which are applied by means of a printing method, and which have one or more dyes and/or pigments which are preferably incorporated in a binder matrix. The color layers, in particular inks, can be transparent, clear, partially scattering, translucent, non-transparent, and/or opaque. For example, a yellow color layer can be provided in the area of the sun 1a and a blue color layer can be provided in the area of the waves 1a.

It is possible that one or more decorative layers of the decorative layers have one or more optically active relief structures, which are preferably introduced in each case into at least one surface of a varnish layer, preferably of a replicated varnish layer.

Relief structures of this type are, in particular, diffractive relief structures, such as for example holograms, diffraction gratings, Fresnel freeform surfaces, diffraction gratings with symmetrical or asymmetrical profile shapes and/or zero-order diffraction structures.

Further preferably, the relief structures are isotropically and/or anisotropically scattering matte structures, blazed gratings and/or relief structures with substantially reflective and/or transmissive action, such as for example microlenses, microprisms or micromirrors.

It is possible that one or more decorative layers of the decorative layers have one or more liquid crystal layers, which generate for one thing preferably a reflection and/or transmission of incident light dependent on the polarization of the incident light and for another preferably a wavelength-selective reflection and/or transmission of incident light, depending on the alignment of the liquid crystals.

The one or more structures of the one or more structures and/or the at least one pixel array are preferably introduced into a thin-film structure, in particular into a Fabry-Perot layer structure. The thin-film structure is preferably applied to the one or more structures and/or to the at least one pixel array. In particular, a Fabry-Perot layer structure of this type has, in particular at least in areas, at least one first semi-transparent absorber layer, at least one transparent spacer layer and at least one second semi-transparent absorber layer and/or an opaque reflective layer. All these layers of the thin-film structure can in particular in each case be present over the whole surface or partially and the transparent and opaque or semi-transparent areas can in particular either overlap or not overlap.

The first semi-transparent absorber layer in particular has a layer thickness of between 5 nm and 50 nm. The absorber layer preferably features aluminum, silver, copper, tin, nickel, Inconel, titanium and/or chromium. In the case of aluminum and chromium, the first semi-transparent absorber layer preferably has a layer thickness of between 5 nm and 15 nm.

The transparent spacer layer preferably has a layer thickness of between 100 nm and 800 nm and in particular between 300 nm and 600 nm. The spacer layer preferably consists of organic material, in particular of polymer, and/or of inorganic Al₂O₃, SiO₂ and/or MgF₂.

Further preferably, the transparent spacer layer consists of a printed polymer layer, which is applied in particular by means of gravure printing, slot casting or inkjet printing.

It is further also possible to combine and/or to use one or more optically variable elements 1a and/or the strip-shaped security element 1b′ and/or one or more layers of the above layers and/or the substrate 10, for example, with the following further layers and/or multilayer structures: one or more HRI layers comprising ZnS, TiO₂, etc., in particular applied over the whole surface or partially by vapor deposition, sputtering or by means of Chemical Vapor Deposition (CVD); one or more HRI or LRI varnish layers (for example for optical effects in transmission), in particular applied over the whole surface or partially by means of gravure printing; one or more metals comprising aluminum, silver, copper and/or chromium and/or alloys thereof, in particular vapor deposited or sputtered, in particular by means of cathode sputtering, and/or printed as ink comprising nanoparticles, over the whole surface or partially; one or more interference layer structures comprising HLH (sequence consisting of HRI layer, LRI layer, HRI layer), HLHLH (sequence consisting of HRI layer, LRI layer, HRI layer, LRI layer, HRI layer); sequences consisting of one or more HRI and LRI layers, wherein the HRI and LRI layers preferably alternate with each other, as well as a Fabry-Perot three layer system, in particular comprising one or more PVD and/or CVD spacer layers; one or more liquid crystal layers; use as exposed master in a volume hologram; superposition with one or more glazing ink layers; and/or use as template for the generation of Aztec structures and/or for conversion to a multi-step phase relief, which provides at least one color effect.

In particular the superposition with the one or more glazing ink layers advantageously provides the possibility of generating memorable optical effects that are easy to make clear. Further preferably, the achromatically diffracted effects of the at least one pixel array of an optically variable element, generated by a superposition with the one or more glazing ink layers, appear monochromatically in the color which is transmitted through the one or more glazing ink layers, or is not filtered out by the one or more glazing ink layers. In particular, the one or more glazing ink layers act a color filter.

The two optically variable elements 1a in each case preferably comprise at least one pixel array, wherein each of the pixel arrays has two or more pixels, wherein one or more pixels of the two or more pixels of the respective pixel array (2) have one or more structures, and wherein one or more structures of the one or more structures project, diffract and/or scatter incident electromagnetic radiation at one or more solid angles.

FIG. 1a illustrates in particular the definition of the solid angle, by which is preferably meant the surface area of a partial surface A of a spherical surface of a sphere E, wherein the surface area of a partial surface A is preferably divided by the square of the radius R of the sphere. The numerical values of the solid angle preferably indicate the angle α of the light cone in relation to the perpendicular z axis. The opening angle Ω preferably indicates the width of the light cone in relation to the straight line in the center of the light cone, marked by an arrow in FIG. 1a. The direction of the light cone in relation to the x or y axis depends in particular on the optical effect aimed for.

A method for producing an optically variable security element, in particular the optically variable security element 1a, is preferably characterized by the following steps:
providing at least one virtual pixel array comprising two or more virtual pixels;
allocating at least one solid angle to one or more virtual pixels of the two or more virtual pixels of the at least one virtual pixel array;
arranging one or more virtual field sources in and/or on at least one area and/or at least one segment of the at least one allocated solid angle, wherein the at least one area or the at least one segment of the at least one allocated solid angle is arranged at a first distance from the one or more virtual pixels of the two or more virtual pixels of the at least one virtual pixel array;
calculating one or more virtual electromagnetic fields emanating from the one or more virtual field sources at a predefined distance from the one or more virtual pixels of the two or more virtual pixels of the at least one virtual pixel array in and/or on the one or more virtual pixels of the two or more virtual pixels of the at least one virtual pixel array and/or in and/or on the surface, in particular plane, spanned by the at least one virtual pixel array;
calculating one or more phase images for the one or more virtual pixels of the two or more virtual pixels of the at least one virtual pixel array from a total virtual electromagnetic field consisting of the superposition of the one or more virtual electromagnetic fields in and/or on the one or more virtual pixels of the two or more virtual pixels of the at least one virtual pixel array and/or in and/or on the surface, in particular plane, spanned by the at least one virtual pixel array;
calculating virtual structure profiles for the one or more virtual pixels of the two or more virtual pixels of the at least one virtual pixel array from the one or more phase images;
forming the virtual structure profiles of the one or more virtual pixels of the two or more pixels of the at least one virtual pixel array in and/or on a substrate as at least one pixel array comprising two or more pixels, wherein one or more pixels of the two or more pixels of the at least one pixel array have one or more structures, for providing the optically variable element.

It is possible that the at least one allocated solid angle and/or the at least one area of the at least one allocated solid angle spans the segment S, wherein the segment S in particular corresponds to a segment of a sphere, preferably a conical segment, wherein for example half the opening angle, in particular θ/2 and/or φ/2, of the segment S shown in FIG. 11 is smaller than 10°, preferably smaller than 5°, further preferably smaller than 1°.

It is further possible that the virtual field sources, which are arranged in particular in and/or on one or more partial areas of the segment S shown in FIG. 11 or 12 and/or on the at least one area of the at least one allocated solid angle, are arranged periodically and/or pseudo-randomly and/or randomly in at least one direction on one or more partial areas of the one or more partial areas of the segment S shown in FIG. 11 or 12 and/or on the at least one area of the at least one allocated solid angle.

It is also possible that the distances between adjacent virtual field sources lie between 0.01 mm and 100 mm, in particular between 0.1 mm and 50 mm, preferably between 0.25 mm and 20 mm, in and/or on one or more partial areas of the one or more partial areas of the segment S shown in FIG. 11 or 12 and/or the at least one area of the at least one allocated solid angle, and/or that the distances between adjacent virtual field sources in particular lie on average between 0.01 mm and 100 mm, in particular between 0.1 mm and 50 mm, preferably between 0.25 mm and 20 mm, in and/or on one or more partial areas of the one or more partial areas of the segment S shown in FIG. 11 or 12 and/or of the at least one area of the at least one allocated solid angle.

It is further also possible that the arrangement of the virtual field sources, in particular of the virtual point field sources, as a crossed grid, preferably an equidistant crossed grid, is effected on one or more partial areas of the one or more partial areas of the segment S shown in FIG. 11 or 12 and/or of the at least one area of the at least one allocated solid angle, wherein the distance of adjacent virtual field sources from each other is between 0.01 mm and 100 mm, in particular between 0.1 mm and 50 mm, preferably between 0.25 mm and 20 mm, and/or wherein the angle between two adjacent virtual field sources, in particular relative to the position of the respective one or more virtual pixels of the two or more virtual pixels of the at least one virtual pixel array, is smaller than 1°, preferably smaller than 0.5°.

One or more virtual field sources of the one or more virtual field sources preferably have the form of microsymbols, in particular selected from: letter, portrait, image, alphanumeric character, character, geometric freeform, square, triangle, circle, curved line, outline.

The lateral dimensions of the microsymbols further preferably lie between 0.1° and 10°, in particular between 0.2° and 5°.

Preferably, a first group of one or more virtual field sources of the one or more virtual field sources cannot be projected onto a screen from a distance of 0.3 m, in particular from 0.15 m to 0.45 m, and/or a second group of one or more virtual field sources of the one or more virtual field sources can be projected onto a screen from a distance of 1.0 m, in particular from 0.8 m to 1.2 m.

In particular preferably, the virtual electromagnetic field which emanates from one or more of the virtual field sources, in particular emanates from all of the virtual field sources, has the same intensity and/or the same intensity distribution over the at least one allocated solid angle and/or over the at least one area and/or over the at least one segment and/or over the segment S of the at least one allocated solid angle.

It is further possible that the virtual electromagnetic field which emanates from one or more of the virtual field sources, in particular emanates from all of the virtual field sources, has an intensity distribution over the at least one allocated solid angle and/or over the at least one area and/or over the at least one segment and/or over the segment S of the at least one allocated solid angle, which has a Gaussian or super-Gaussian distribution.

It is also possible that the virtual electromagnetic field which emanates from two or more of the virtual field sources, in particular emanates from all of the virtual field sources, has different intensities and/or different intensity distributions over the at least one allocated solid angle and/or over the at least one area and/or over the at least one segment and/or over the segment S of the at least one allocated solid angle.

It is further also possible that the virtual electromagnetic field which emanates from one or more of the virtual field sources, in particular emanates from all of the virtual field sources, has an isotropic or an anisotropic intensity distribution over the at least one allocated solid angle and/or over the at least one area and/or over the at least one segment and/or over the segment S of the at least one allocated solid angle.

In particular, one or more of the virtual field sources, in particular all of the virtual field sources, form a virtual point field source, wherein the virtual point field source preferably emits a virtual spherical wave.

The virtual electromagnetic field Uᵢ emanating from an i-th virtual point field source at the location (xᵢ, yᵢ, zᵢ) is at least at one coordinate (xₕ, yₕ, zₕ), in particular a coordinate (xₕ, yₕ, zₕ=0)=(xₕ, yₕ), in and/or on one or more virtual pixels of the two or more virtual pixels 4aa-4dd of the at least one virtual pixel array 4 and/or in and/or on the surface, in particular plane, spanned by the at least one virtual pixel array 4, and/or for example in the pixels 2aa-2dd, 2aa-2dd, 2ad, 2da, 2da and 2da, respectively, shown in FIG. 2, 9, 10, 11, 12 or 12a, is preferably calculated by means of the equation

$${U}_{i} ( {x}_{h} , {y}_{h} ) = \frac{exp ( ikr )}{r} , r = \sqrt{{( {x}_{h} - {x}_{i} )}^{2} + {( {y}_{h} - {y}_{i} )}^{2} + {z}_{i}^{2}} , .$$

It is possible that the virtual electromagnetic field Uᵢ comprises one or more wavelengths, which lie in particular in the visible spectral range of from 380 nm to 780 nm, preferably from 430 nm to 690 nm, wherein one or more in each case adjacent wavelengths of the one or more wavelengths, preferably in the visible spectral range, are spaced apart from each other, preferably equidistantly.

The virtual electromagnetic field Uᵢ preferably comprises one or more wavelengths which are larger, by a factor of 2 to 40, in particular by a factor of 3 to 10, preferably by a factor of 4 to 8, than one or more wavelengths of incident electromagnetic radiation.

It is further possible that the virtual electromagnetic field Uᵢ comprises one or more wavelengths which lie in particular in the infrared, visible and/or ultraviolet spectral range, wherein one or more in each case adjacent wavelengths of the one or more wavelengths, preferably in the infrared, visible and/or ultraviolet spectral range, are spaced apart from each other, preferably equidistantly.

The total virtual electromagnetic field Uₚ in and/or on one or more virtual pixels of the two or more virtual pixels 4aa-4dd of the at least one virtual pixel array 4 and/or in and/or on the surface, in particular plane, spanned by the at least one virtual pixel array 4, and/or for example in the pixels 2aa-2dd, 2aa-2dd, 2ad, 2da, 2da and 2da, respectively, shown in FIG. 2, 9, 10, 11, 12 or 12a, is preferably calculated by means of the equation

$${U}_{p} ( {x}_{p} , {y}_{p} ) = {U}_{r}^{*} ( {x}_{p} , {y}_{p} ) {\sum }_{i = 1}^{{N}_{p}} {U}_{i} ( {x}_{p} , {y}_{p} ) ,$$

wherein in particular the virtual electromagnetic fields Uᵢ emanating from i=1, Nₚ virtual point field sources at least at one coordinate (xₚ, yₚ, zₚ=0)=(xₚ, yₚ) and/or in particular the optional reference wave Uᵣ*, preferably the at least one optional reference wave Uᵣ*, at least at one point or for the parameters (xₚ, yₚ) in and/or on the one or more virtual pixels of the two or more virtual pixels 4aa-4dd of the at least one virtual pixel array 4 and/or in and/or on the surface, in particular plane, spanned by the at least one virtual pixel array 4, are calculated.

It is possible that one or more phase images of the one or more phase images are converted into one or more virtual structure profiles, preferably converted linearly into a virtual structure profile, wherein a phase value of 0 corresponds to the minimum depth and a phase value of 27 corresponds to the maximum depth of the formed one or more structures of one or more pixels of the two or more pixels of the at least one pixel array.

It is further possible that the virtual structure profile of one or more virtual pixels of the two or more virtual pixels of the at least one virtual pixel array is formed by means of laser exposure and development on a plate coated with photoresist and/or by means of electron-beam lithography as the one or more structures of one or more pixels of the two or more pixels of the at least one pixel array.

It is also possible that one or more structures comprised or formed in one or more pixels of the two or more pixels of the at least one pixel array have an optical depth, in particular an optical depth in air, of half the average wavelength of the virtual electromagnetic field and/or of the total virtual electromagnetic field.

Further preferably, a method for producing a security document, in particular the security document 1d, preferably comprising one or more layers, further preferably comprising one or more optically variable elements, in particular preferably the optically variable elements 1a, is characterized by the following steps:
applying and/or introducing one or more optically variable elements to the security document and/or to one or more layers of the security document and/or into the security document and/or into one or more layers of the one or more layers of the security document as a laminating film and/or as an embossing film.

FIG. 2 shows a pixel array in top view comprising sixteen pixels 2aa-2dd, wherein the pixels 2aa-2dd are arranged as a 4×4 matrix, which has four rows and four columns. The first row comprises, along the x direction, the pixels 2aa, 2ab, 2ac, 2ad, the second row comprises, along the x direction, the pixels 2ba, 2bb, 2bc, 2bd, the third row comprises, along the x direction, the pixels 2ca, 2cb, 2cc, 2cd, and the fourth row comprises, along the x direction, the pixels 2da, 2db, 2dc, 2dd. The first column comprises, along the y direction, the pixels 2da, 2ca, 2ba, 2aa, the second column comprises, along the y direction, the pixels 2db, 2cb, 2bb, 2ab, the third column comprises, along the y direction, the pixels 2dc, 2cc, 2bc, 2ac, and the fourth column comprises, along the y direction, the pixels 2dd, 2cd, 2bd, 2ad.

The pixels 2aa-2dd shown in FIG. 2 have the same lateral dimensions ΔX along the x direction and the same lateral dimensions ΔY along the y direction, wherein in each case they form square shapes in the plane spanned by the x and y directions.

It is also possible that, in particular in the plane defined by the pixel array 2 and/or in the plane defined by the x and y directions, one or more or all pixels of the one two or more pixels 2aa-2dd form shapes that are identical to or different from each other, which are preferably selected in each case from: circular surface, egg-shaped surface, elliptical surface, triangular surface, square surface, rectangular surface, polygonal surface, annular surface, freeform surface, wherein, in the case of the selection of the shape of the pixels as a circular surface and/or egg-shaped surface, the two or more pixels in particular in each case have one or more adjacent background surfaces, which preferably also adjoin or do not adjoin adjacent pixels. The shape of the pixels in particular varies polygonally, randomly or pseudo-randomly. Further preferably, the at least one pixel array, in particular the pixel array 2, comprises two or more pixels which preferably comprise different shapes of the above shapes and/or preferably have different variations of the shapes of the above variations of shapes.

It is further also possible that one or more or all pixels of the two or more pixels 2aa-2dd have different lateral dimensions in different directions, in particular in the different directions x and y, in particular in the plane defined by the pixel array 2 and/or in the plane defined by the x and y directions.

It is also possible that one or more or all pixels of the two or more pixels 2aa-2dd occupy different surfaces and/or overlap and/or do not overlap, in particular in the plane defined by the pixel array 2 and/or in the plane defined by the x and y directions.

It is further possible that the arrangement of the pixels 2aa-2dd in the pixel array 2 follows a periodic function. For example, the centers of the pixels in a row or column of the pixel array can be arranged in such a way that the centers of the pixels of in each case adjacent pixels are preferably equally spaced apart along a direction defined by the column or row. The pixels 2aa-2dd shown in FIG. 2 have in each case equal distances from each other along the x or y directions, wherein this relates in particular to adjacent pixels of the pixels 2aa-2dd. Further preferably, one or more or all pixels of the pixels 2aa-2dd are arranged non-periodically or in particular randomly or pseudo-randomly in the pixel array 2 and/or along one or more directions and/or in the plane spanned or defined by the x and y directions.

By a center of the pixels or a geometric center of the pixels is meant, in particular in the case of two-dimensional pixels, the centroid of an area, which is determined in particular in the averaging of all points of the underlying pixel.

A non-periodic arrangement of pixels has the advantage that disruptive diffraction effects which form because of the size or shapes and/or lateral dimensions of the pixels can be reduced or suppressed, in particular completely suppressed.

The lateral dimensions of one or more pixels of the pixels 2aa-2dd along at least one direction, in particular along the x direction and/or along the y direction, are preferably between 5 μm and 500 μm, in particular between 10 μm and 300 μm, in particular between 20 μm and 150 μm.

In such lateral dimensions the advantage is inherent that, with these orders of magnitude of the lateral dimensions, pixels cannot be resolved or can hardly be resolved optically by the eye of a human observer, in particular at a usual or normal reading distance of approximately 300 mm. At the same time, the pixels are in particular large enough that the microstructures provided can have an achromatic action.

It is possible that the pixel size and/or one or more lateral dimensions of one or more pixels of the pixels 2aa-2dd in the at least one pixel array 2 vary non-periodically, periodically, pseudo-randomly or randomly in one or more directions, in particular in one or both directions of the x and y directions, preferably in areas, or do not vary. The pixel sizes in at least one pixel array preferably vary by at most ±70% around an average value, preferably by at most ±50%, in at least one spatial direction. One or more lateral dimensions of one or more pixels of the two or more pixels 2aa-2dd in the at least one pixel array 2 preferably vary in one or more spatial directions, in particular in one or both directions of the x and y directions, in the at least one pixel array 2, at least in areas, by at most ±70%, preferably by at most ±50%, around an average value, wherein the average value in one or more directions in particular lies between 5 μm and 500 μm, in particular between 10 μm and 300 μm, in particular between 20 μm and 150 μm.

It is further possible that one or more pixels of the pixels 2aa-2dd in the at least one pixel array 2 are arranged periodically, non-periodically, fractally, randomly and/or pseudo-randomly in the at least one pixel array 2, in particular at least in areas.

FIG. 3 shows the pixel array 2 shown in FIG. 2 comprising the pixels 2ca, 2cb, 2cc, 2cd, along the section Q in a cross section. The pixel 2ca comprises the structure 3ca, the pixel 2cb comprises the structure 3cb, the pixel 2cc comprises the structure 3cc and the pixel 2cd comprises the structure 3cd. The structures 3ca, 3cb, 3cc and 3cd are applied, deposited and/or molded onto a substrate 10, wherein the substrate in particular has one or more layers.

FIG. 3a shows a further embodiment of the pixel array 2 shown in FIG. 2 comprising the pixels 2ca, 2cb, 2cc, 2cd, along the section Q in a cross section. The pixel 2ca comprises the structure 3ca, the pixel 2cb comprises the structure 3cb, the pixel 2cc comprises the structure 3cc and the pixel 2cd comprises the structure 3cd. The structures 3ca, 3cb, 3cc and 3cd are applied, deposited and/or molded onto a substrate 10, wherein the substrate in particular has one or more layers. In contrast to FIG. 3, in this embodiment the structures 3ca, 3cb, 3cc and 3cd are in particular binary structures with a first distance or a uniform structure height h.

Here, the binary structures 3ca, 3cb, 3cc and 3cd or binary microstructures shown in FIG. 3a, preferably comprising one or more structure elements, in particular have a base surface GF and several structure elements, which preferably in each case have an element surface EF raised compared with the base surface GF and preferably a flank arranged between the element surface EF and the base surface GF, wherein in particular the base surface GF of the structure 3ca, 3cb, 3cc and 3cd defines a base plane spanned by co-ordinate axes x and y, wherein the element surfaces EF of the structure elements in each case preferably run substantially parallel to the base plane GF and wherein the element surfaces EF of the structure elements and the base surface GF are preferably spaced apart in a direction running perpendicular to the base plane in the direction of a co-ordinate axis z, in particular with a first distance h, which is preferably chosen such that, in particular by interference of the light reflected on the base surface GF and the element surfaces EF in reflected light and/or in particular by interference of the light transmitted through the element surfaces EF and the base surface GF in transmitted light, a second color is generated in the one or more first zones. Here, the second color is preferably generated in direct reflection or transmission and in particular the first color, complementary thereto, is generated in the first or in higher orders. For example, the first color can be violet and the second color orange, or the first color can be blue and the second color yellow.

It is possible that the optically variable element 1a comprises one or more layers, wherein in particular the at least one pixel array 2 is arranged on or in at least one layer of the one or more layers and wherein one or more layers of the one or more layers are preferably selected from: HRI layer, in particular layer comprising HRI and/or LRI varnish layer, metal layer, interference layer, in particular interference layer sequences, preferably HLH or HLHLH, further preferably Fabry-Perot three layer system or multilayer system, liquid crystal layer, color layer, in particular glazing ink layer.

Each of the structures 3ca, 3cb, 3cc, 3cd preferably has a restricted maximum structure depth Δz, in particular a maximum structure depth, which in FIG. 3 is in particular the same for all structures 3ca, 3cb, 3cc, 3cd in the corresponding pixels 2ca, 2cb, 2cc, 2cd.

One or more structures of the one or more structures 3ca, 3cb, 3cc, 3cd further preferably have a restricted maximum structure depth Δz, wherein the maximum structure depth Δz in particular is smaller than 35 μm, preferably smaller than 20 μm, further preferably smaller than or equal to 15 μm, even further preferably smaller than or equal to 7 μm, in particular preferably smaller than or equal to 2 μm.

In particular, the advantage results here that the thickness or the overall thickness of the optically variable element 1a comprising the at least one pixel array 2 is kept compatible for use in security documents 1d, in particular on banknotes, ID cards or passports.

In particular, the overall thickness of film-based optically variable elements 1a, preferably security elements and/or decorative elements, preferably on banknotes, ID cards or passports, is smaller than 35 μm. It is preferred that the overall thickness is smaller than 20 μm, in order in particular to advantageously prevent banknotes from being bent out of shape because of an applied film comprising one or more optically variable elements 1a. It is further possible that to restrict the restricted maximum structure depth of all structures 3ca, 3cb, 3cc, 3cd of the corresponding pixels 2ca, 2cb, 2cc, 2cd such that the structures 3ca, 3cb, 3cc, 3cd are preferably applied, deposited and/or molded by means of a replication method.

It is possible that one or more structures of the one or more structures 3ca, 3cb, 3cc, 3cd are formed in such a way that the restricted maximum structure depth Δz of the one or more structures 3ca, 3cb, 3cc, 3cd is smaller than or equal to 15 μm, in particular smaller than or equal to 7 μm, preferably smaller than or equal to 2 μm, for more than 50% of the pixels, in particular for more than 70% of the pixels, preferably for more than 90% of the pixels, of the at least one pixel array 2.

It is further possible that one or more structures of the one or more structures 3ca, 3cb, 3cc, 3cd are formed in such a way that the maximum structure depth Δz of the one or more structures is smaller than or equal to 15 μm, in particular smaller than or equal to 7 μm, preferably smaller than or equal to 2 μm, for all pixels.

A restricted maximum structure depth of smaller than or equal to 15 μm is advantageously compatible in particular with methods comprising UV replications (UV=ultraviolet) and a restricted maximum structure depth smaller than or equal to 7 μm, in particular smaller than or equal to 2 μm, is advantageously compatible in particular with methods comprising UV replication and/or thermal replications.

It is also possible that one or more structures of the one or more structures 3ca, 3cb, 3cc, 3cd have a grating period in particular smaller than half, preferably smaller than a third, further preferably smaller than a quarter, of the maximum lateral dimension of the pixels 2ca, 2cb, 2cc, 2cd, preferably than each of the pixels 2ca, 2cb, 2cc, 2cd.

Further, it is in particular possible that one or more structures of the one or more structures 3ca, 3cb, 3cc, 3cd are different from or similar to or the same as or identical to each other.

FIG. 4 shows the pixel array 2 shown in FIG. 2 except that a corresponding structure 3aa-3dd is allocated to each of the pixels 2aa-2dd or that each of the pixels 2aa-2dd comprises a corresponding structure 3aa-3dd, wherein the structures 3aa-3dd are formed as hologram-like structures in particular achromatically projecting, diffracting and/or scattering incident light.

In particular, one or more or all of the structures of the structures 3aa-3dd have different optical properties from each other.

It is possible that one or more structures of the one or more structures 3aa-3dd are allocated to each pixel of the pixels 2aa-2dd of the at least one pixel array 2, wherein the one or more structures allocated to a pixel project, diffract and/or scatter incident electromagnetic radiation at one or more predefined solid angles, wherein in particular a direction, preferably a predefined direction, is allocated in each case to the one or more predefined solid angles.

It is further possible that one or more structures of the one or more structures 3aa-3dd and/or one or more allocated structures of the one or more allocated structures 3aa-3dd project, diffract and/or scatter at one or more solid angles of the one or more solid angles and/or one or more predefined solid angles of the one or more predefined solid angles, which in particular differ from each other, wherein one or more solid angles of the one or more solid angles and/or predefined solid angles of the one or more predefined solid angles projected onto a sphere, in particular a unit sphere with a unit radius of 1, arranged around a pixel form one or more, in particular identical or different shapes, which are preferably selected in each case from: circular surface, elliptical surface, triangular surface, square surface, rectangular surface, polygonal surface, annular surface, wherein in particular one or more shapes of the one or more shapes are open or closed and/or consist of one or more partial shapes and wherein at least two partial shapes are preferably combined or superposed with each other.

FIG. 5 shows the pixel array 2 shown in FIG. 2 except that a corresponding structure 3aa-3dd is allocated to each of the pixels 2aa-2dd or that each of the pixels 2aa-2dd comprises a corresponding structure 3aa-3dd, wherein the structures 3aa-3dd are formed as grating structures, which project, diffract and/or scatter incident light achromatically. In particular, the grating structures are linear grating structures, which preferably have a blaze-like grating profile.

In one or more pixels of the pixels 2aa-2dd in the at least one pixel array 2, the achromatically diffracting grating structures are preferably superposed with further microstructures and/or nanostructures, in particular linear grating structures, preferably crossed grating structures, further preferably subwavelength grating structures.

It is possible that the one or more structures of the one or more structures 3aa-3dd, which are formed as achromatically diffracting grating structures, preferably as blazed gratings, in particular have a grating period larger than 3 μm, preferably larger than 5 μm, and/or in particular each pixel of the pixels 2aa-2dd comprises at least two grating periods of the achromatically diffracting structures.

FIG. 6 shows the pixel array 2 shown in FIG. 2 except that a corresponding structure 3aa-3dd is allocated to each pixel of the pixels 2aa-2dd or that each pixel of the pixels 2aa-2dd comprises a corresponding structure 3aa-3dd, wherein the structures 3aa-3dd are formed as Fresnel microlens structures and/or partial areas or sections of Fresnel microlens structures, wherein in particular the grating lines of the Fresnel microlens structures are formed as curved grating lines and/or have grating lines with varying grating periods and/or wherein in particular each pixel of the two or more pixels comprises at least two grating periods, preferably in at least one spatial direction.

It is possible that the Fresnel microlens structures are designed as blazed gratings, wherein the grating lines are in particular curved and/or wherein the grating period preferably varies.

In particular, one or more or all of the structures are less preferably formed as micromirrors and/or microprisms, in particular less preferably as achromatically refractively projecting microstructures.

It is further possible that more than 70% of the pixels, in particular more than 90% of the pixels, of the pixels 2aa-2dd in the at least one pixel array 2 have one or more structures of the one or more structures 3aa-3dd, which have a quantity of at least 2 elevations, in particular at least 3 elevations, preferably at least 4, per pixel.

Further preferably, one or more structures of the one or more structures have a quantity of at least 2 elevations, in particular at least 3 elevations, preferably at least 4 elevations, per pixel.

Preferably, at least two grating periods of the structures formed as blazed gratings and/or Fresnel microlens structures lie in at least one pixel, wherein the grating period here is preferably smaller than half the maximum lateral dimension of each pixel.

It is also possible that one or more structures of the one or more structures 3aa-3dd are formed as chromatic grating structures, in particular as linear gratings, preferably as linear gratings with a sinusoidal profile, and/or as nanotext and/or as mirror surfaces. It is thereby possible in particular to integrate colored design elements and/or hidden features into the achromatically appearing pixel array.

FIG. 7 shows the pixel array 2 shown in FIG. 2 except that the pixels 2aa, 2ad and 2cc in each case have a linear grating 30aa, 30ad and 30cc, respectively, in particular comprising a sinusoidal profile.

It is possible to extend the achromatic effects of the one or more structures 3aa-3dd with further optical effects through the use or application or molding of further structures and in the process advantageously to further increase the protection against forgery.

It is further possible that one or more structures of the one or more structures 3aa-3dd, preferably in one or more pixels of the pixels 2aa-2dd, are formed as subwavelength gratings, in particular as linear subwavelength gratings, wherein the grating period of the subwavelength gratings, in particular of the linear subwavelength gratings, is preferably less than 450 nm and/or wherein in particular at least one pixel array of this type provides an optically variable effect detectable for an observer when the optically variable element and/or the at least one pixel array is tilted and/or rotated. In particular, an optically variable effect of this type is one or more icons, logos, images and/or further motifs detectable by an observer and/or by a sensor, which preferably light up when the optically variable element 1a is tilted strongly.

Also, it is further possible that one or more structures of the one or more structures 3aa-3dd are provided with a metal layer, in particular at least partially, and/or absorb incident electromagnetic radiation, wherein one or more pixels of the two or more pixels are preferably detectable in reflection, preferably in direct reflection, for an observer in dark gray to black.

FIG. 8 shows the pixel array 2 shown in FIG. 2 except that the pixels 2aa, 2ad and 2cc in each case have a light-absorbing, in particular incident light-absorbing, microstructure 31aa, 31ad and 31cc, respectively, wherein these absorbing microstructures 31aa, 31ad and 31cc, respectively, preferably appear dark gray to black for an observer and/or a sensor. In particular, the absorbing microstructures 31aa, 31ad and 31cc, respectively, are formed as subwavelength crossed gratings, in particular with a grating period smaller than or equal to 450 nm, preferably smaller than or equal to 350 nm. Pixels of this type with microstructures appearing dark gray to black make it possible in particular to increase the contrast of the appearance of the pixel array and, for example, to create the illusion of cast shadows.

It is also possible that one or more structures of the one or more structures 3aa-3dd are formed as microstructures which absorb light, in particular absorb incident light, and/or appear colored for an observer and/or a sensor in the case of normal viewing or in direct reflection.

It is possible to extend further structures with further optical effects and in the process advantageously to further increase the protection against forgery.

It is further possible to supplement the achromatic effects of the one or more structures 3aa-3dd with contrast lines or contrast surfaces in a design through the use or application or molding of light-absorbing microstructures in one or more pixels of the pixels 2aa-2dd of the at least one pixel array 2. It is possible in the process, for example, to design a 3D object, such as for example a portrait, that is visually jumping out or towards an observer and/or a sensor and is generated by the structures 3aa-3dd in the corresponding pixels of the pixels 2aa-2dd projecting, diffracting and/or scattering incident light in a targeted manner, to be detectable in higher contrast using the pixels comprising the light-absorbing microstructures appearing dark to black for an observer and/or sensor. In particular, it is possible that the pixels appearing dark represent a cast shadow expected by an observer in higher contrast, for example.

In particular, one or more structures of the one or more structures 3aa-3dd have an HRI layer, wherein in particular the pixels which have the one or more structures are detectable in color in reflection for an observer and/or sensor.

Preferably it is possible, in a quantity of pixels of the pixels 2aa-2dd predefined by a design, to provide microstructures, which, in particular in the case of an at least partial coating with at least one high-refractive dielectric layer, in particular at least one HRI layer, appear colored, for example red or green, when detected by an observer and/or a sensor, preferably in the case of normal viewing or in direct reflection. Microstructures of this type are preferably formed as linear subwavelength gratings, wherein the colored pixels comprising the microstructures of this type, for example in a portrait, generate pupils detectable in green for an observer and/or sensor.

FIG. 9 shows a detail of a pixel array 2 comprising sixteen pixels 2aa-2dd in a perspective top view, wherein the pixel array extends in the plane spanned by the x and y directions. Further, the direction of incidence of an incident light 6 and the directions of emergence of emergent light 20aa-20dd for the corresponding pixels 2aa-2dd are shown in FIG. 9. The emergent light 20aa-20dd in particular radiates into the half space which is defined, in particular, by the plane of the pixel array, wherein the incident light 6 is preferably incident from a direction of this half space. The incident light 6 is diffracted as emergent light 20aa-20dd in particular achromatically in the corresponding directions of the emergent light 20aa-20dd. Here, the incident light 6 is in particular achromatically projected, diffracted and/or scattered pseudo-randomly in any desired spatial directions as emergent light 20aa-20dd in or at each pixel 2aa-2dd, preferably individually in or at each pixel 2aa-2dd comprising a respective structure 3aa-3dd.

It is possible that one or more structures of the one or more structures 3aa-3dd, preferably in the corresponding pixels of the pixels 2aa-2dd, project, diffract and/or scatter incident electromagnetic radiation, in particular incident light 6, pseudo-randomly or randomly in all spatial directions in such a way that one or more pixels of the pixel array 2 is detectable preferably isotropically white, preferably isotropically achromatic, in reflection for an observer and/or a sensor.

FIG. 10 shows an enlarged detail of the pixel array 2 shown in FIG. 9, which comprises for example a pixel 2ad, comprising light-projecting, -diffracting and/or -scattering structures 3ad, which projects, diffracts and/or scatters incident light or incident electromagnetic radiation as emergent light 20ad in a predefined direction and/or at a predefined solid angle. Here, the paths and/or propagation directions of the emergent light 20ad preferably run parallel to each other.

It is also possible that the light incident on the pixel array 2, or the incident electromagnetic radiation, is pseudo-randomly or randomly projected, diffracted and/or scattered as emergent light 2aa-2dd only in at least one area, in particular one or more at least partially coherent or non-coherent and/or at least partially overlapping or non-overlapping areas, of the one or more predefined solid angles. The brightness and/or intensity of the emergent light or of the emergent electromagnetic radiation is hereby advantageously increased in these areas and/or at predefined solid angles, wherein in particular the effect, preferably visual effect, detectable by an observer and/or sensor can be detected better in the case of poor illumination conditions.

It is further also possible, in the case of a severe restriction, in particular of one or more opening angles, one or more of the predefined solid angles of the one or more predefined solid angles in at least one direction, to generate an asymmetrical and/or dynamic white effect. Here, the opening angles of the predefined solid angles are preferably restricted to smaller than +/−10°, preferably smaller than +/−5°, further preferably +/−3°, in particular in at least one direction.

A summary of the most important structural parameters and of the value ranges of these parameters is listed in Table 1.

| Structural | | | Particularly preferred |
|---|---|---|---|
| parameters | Ranges | Preferred ranges | ranges |
| Lateral dimensions | 5 μm to 500 μm | 10 μm to 300 μm | 20 μm to 150 μm |
| of a pixel and/or Δx | | | |
| and/or Δγ | | | |
| Restricted | ≤15 μm | ≤4 μm | ≤2 μm |
| maximum structure | | | |
| depth | | | |
| Distances between | 0.001 m to 100 m | 0.1 m to 5 m | 0.25 m to 2 m |
| adjacent virtual | | | |
| field sources | | | |
| Microlens focal | 0.04 mm to 5 mm | 0.06 mm to 3 mm | 0.1 mm to 2 mm |
| length | | | |
| Quantity of | ≥2 | ≥3 | ≥4 |
| elevations per pixel | | | |

FIG. 11 shows an enlarged detail of the pixel array 2 shown in FIG. 6 comprising the pixel 2da, in which at least one structure 3da is molded as a Fresnel microlens structure, wherein incident light or incident electromagnetic radiation is projected, diffracted and/or scattered, in particular focused, by the structure 3da onto one or more points and/or one or more surfaces in the space perpendicular to the plane spanned by the pixel array 2 and/or to the plane spanned by the x and y directions. FIG. 11 is only schematic and not true to scale.

It is further also possible that one or more structures of the one or more structures are formed as microlenses, in particular Fresnel microlenses, wherein in particular the focal length of the one or more structures is between 0.04 mm and 5 mm, in particular 0.06 mm to 3 mm, preferably 0.1 mm to 2 mm, and/or wherein in particular the focal length in a direction x and/or y is determined by the equation

$${f}_{x , y} = \frac{{Δ}_{x , y} \text{/} 2}{tan ( {ϕ}_{x , y} \text{/} 2 )} ,$$

wherein Δ_{x,y} is preferably the respective lateral dimension of one or more pixels of the two or more pixels of the at least one pixel array in the x direction or in the y direction and ϕ_{x,y} is the respective solid angle in the x direction or in the y direction, at which the one or more structures project, diffract and/or scatter incident electromagnetic radiation, in particular incident light.

It is further possible that one or more structures of the one or more structures are formed as cylindrical lenses, wherein in particular the focal length of the one or more structures is infinitely large.

In particular, the sizes and/or the lateral dimensions of the pixels and/or of the allocated solid angles determine the corresponding focal lengths.

FIG. 12 shows an enlarged detail of the pixel array 2 shown in FIG. 6 comprising the pixel 2da, in which at least one structure 3da is molded as a Fresnel microlens structure, wherein incident light or incident electromagnetic radiation is projected, diffracted and/or scattered, in particular focused, by the structure 3da in a direction R onto one or more points or one or more surfaces in the space, in particular not perpendicular to the plane spanned by the pixel array 2 and/or to the plane spanned by the x and y directions but at an angle α relative to the surface normal f of the above planes.

Here, the radius of the sphere E is equal in particular to the focal height f. The Fresnel microlens structure is preferably calculated or designed for a wavelength of 550 nm, in particular a wavelength range of from 450 nm to 650 nm, of the incident light.

FIG. 12a shows an enlarged detail of the pixel array 2 shown in FIG. 6 comprising the pixel 2da, in which at least one structure 3da is molded as a Fresnel microlens structure, wherein incident light or incident electromagnetic radiation is projected, diffracted and/or scattered, in particular focused, by the structure 3da in a direction R onto one or more points or one or more surfaces in the space, in particular not perpendicular to the plane spanned by the pixel array 2 and/or to the plane spanned by the x and y directions but at an angle α relative to the surface normal f of the above planes.

In particular, at least one virtual pixel array comprising two or more virtual pixels is provided in and/or on the segments S shown in FIGS. 11, 12 and 12a, wherein at least one solid angle is preferably allocated to each of the one or more virtual pixels of the two or more virtual pixels of the at least one virtual pixel array. The half opening angles of the allocated solid angle shown in FIG. 11, which is delimited by the lines 20da, are, for example, θ/2 and φ/2. In FIGS. 11, 12 and 12a, in each case one virtual pixel is preferably allocated to the respective pixels 2da.

Further preferably, one or more virtual field sources are arranged in and/or on the segments S shown in FIGS. 11, 12 and 12a, wherein in particular the segments S shown in FIGS. 11, 12 and 12a are arranged in each case at first distances from the respective virtual pixels, wherein the position and/or alignment of the respective virtual pixel in FIG. 11, 12 or 12a, respectively, preferably corresponds in each case to the position and/or alignment of the respective pixels 2da shown in FIGS. 11, 12 and 12a.

One or more virtual electromagnetic fields emanating from the one or more virtual field sources, in particular arranged in the segments S shown in FIGS. 11, 12 and 12a, at a predefined distance from one or more virtual pixels of the two or more virtual pixels of the at least one virtual pixel array are preferably calculated in and/or on the one or more virtual pixels of the two or more virtual pixels of the at least one virtual pixel array and/or in and/or on the surface, in particular plane, spanned by the at least one virtual pixel array.

One or more phase images for one or more virtual pixels of the two or more virtual pixels of the at least one virtual pixel array are preferably calculated from a total virtual electromagnetic field consisting of the superposition of the one or more virtual electromagnetic fields in and/or on the one or more virtual pixels of the two or more virtual pixels of the at least one virtual pixel array and/or in and/or on the surface, in particular plane, spanned by the at least one virtual pixel array, wherein the respective planes in FIGS. 11, 12 and 12a correspond in particular to the planes spanned by the respective pixels 2da.

Further preferably, virtual structure profiles are calculated for the one or more virtual pixels of the two or more virtual pixels of the at least one virtual pixel array from the one or more phase images.

In particular preferably, the virtual structure profiles of the two or more virtual pixels of the at least one virtual pixel array are formed in and/or on a substrate, to provide an optically variable element, as at least one pixel array comprising two or more pixels, wherein the respective pixels 2da shown in FIGS. 11, 12 and 12a of the at least one pixel array have one or more structures 3da.

FIG. 13 shows a design comprising a 3D model of the portrait 9 of the mathematician and physicist Carl Friedrich Gauβ by way of example. The six variants in the upper part of the figure in each case have, from left to right, an increasing opening angle of the solid angles by which the corresponding microstructures of the underlying pixel array project, diffract and/or scatter incident light or incident electromagnetic radiation widened by the respectively predefined solid angle. In particular, the opening angles of the respective allocated solid angles at which the corresponding structures project the incident light widened are, from left to right: 0.5°, 1.25°, 2.5°, 5°, 7.5°, 10°.

In particular, a small and/or smaller opening angle of the predefined solid angles generates a 3D effect, detectable for an observer and/or sensor, with a surface of the portrait or of a motif appearing smooth. A large and/or larger opening angle of the solid angles preferably generates a 3D effect, detectable for an observer and/or sensor, with surfaces of the portrait or of a motif appearing strongly matte. This controlled matteness can be used as a design element, for example in order to allow the peak of a mountain represented as a 3D effect to look snow-covered.

The opening angle preferably lies in the range between 0.5° and 70° and preferably between 1° and 60°.

The upper part of FIG. 13b shows five details 91, 92, 93, 94, 95 of a 3D model of a lion, wherein in particular the opening angle increases from 1° to 60° from left to right. All of the pixels diffract the incident light in particular with approximately the same opening angle in the direction provided for the pixel. The detail 91 of the lion on the far left has a reflective virtual surface; the detail 95 of the lion on the far right has a semigloss surface. The three details 92, 93, 94 of lions in between show intermediate values of matteness.

It is further possible to allow a partial area of the 3D effect to appear in a different matteness. The lower part of FIG. 13b shows this with reference to a 3D model of a lion 96, 97, wherein on the left, in a K-shaped partial area of the lion 96, the matteness is greater than in the rest of the lion and in the right-hand lion 97, in the K-shaped partial area of the lion, the matteness is smaller than in the rest of the lion. In the left-hand lion 96, the opening angle is 1° in the areas without K-shaped partial area and, in the right-hand lion 97, the opening angle is 15°. The K-shaped partial area in the left-hand lion 96 has an opening angle of 60° and the K-shaped partial area in the right-hand lion 97 has an opening angle of 1°.

The lower parts of FIG. 13 show microscope images of details of the underlying pixel array of the portrait shown in the upper part of FIG. 13 in different enlargements of the respective areas. In particular, the structures comprised by the pixels arranged in the pixel arrays can be detected.

In particular, a change of the predefined solid angles at which the pixels project, diffract and/or scatter the incident light preferably leads to a clear change of the underlying structures and, as the opening angles become larger, in particular to a clear deviation from regular or periodic structures.

FIG. 14 shows, by way of example, such a change of a structure of a selected pixel of the design shown in FIG. 13, wherein the structure changes from left to right as the opening angle becomes larger.

It is further possible to make a 3D effect, in particular as described above, partially or completely or entirely visible or detectable only in a predefined direction. For this purpose, the structures in the pixels are preferably chosen such that they project and/or diffract and/or scatter incident electromagnetic radiation in the predefined area of the 3D effect preferably substantially in the predefined direction. The opening angle here is chosen in particular dependent on direction.

The left-hand part 98 of FIG. 13c shows a design comprising a 3D model of the portrait of the mathematician and physicist Carl Friedrich Gauβ, wherein, in the case of normal viewing, the face preferably projects and/or diffracts and/or scatters incident electromagnetic radiation substantially in the direction of an observer. This area of the portrait in particular appears domed in 3D and bright matte. The other areas of the portrait, on the other hand, preferably appear dark to barely perceptible. In particular after rotating the optically variable element clockwise by 90°, as shown in the right-hand part 99 of FIG. 13c, in contrast the face preferably appears dark to barely perceptible and the remaining areas of the portrait in particular appear domed in 3D and bright matte. Here, the opening angle preferably lies in a range between 0.5° and 70°, further preferably between 1° and 60°.

It is possible that the structures, formed as an achromatic microstructure, in one or more or all pixels of the two or more pixels of the at least one pixel array are superposed with further microstructures and/or nanostructures. Examples of such further microstructures and/or nanostructures are linear grating structures, crossed grating structures, in particular subwavelength grating structures. It is possible here to achieve a combination of the achromatic effect generated by the achromatic structures with a color effect generated by subwavelength grating structures, in particular with so-called zero-order diffraction color effects. Examples of such zero-order diffraction color effects are in particular so-called resonant gratings in the case of an HRI coating or gratings with effects based on plasmon resonance in the case of metal coatings, in particular aluminum coating. In both cases mentioned, the optical effect of the at least one pixel array forms in particular in the color of the superposed subwavelength grating structure effects. The grating period for the resonant gratings, which are coated with HRI, preferably lies in the range of from 200 nm to 500 nm. Furthermore, the subwavelength grating structures of the resonant gratings are preferably linear gratings.

It is further possible, as an alternative to dividing at least one pixel array or one surface into pixels with different allocated and/or predefined solid angles, to cover surfaces or adjacent pixels in particular with identical or almost identical structures and/or microstructures.

FIG. 15 shows an arrangement of pixels of a pixel array 2 comprising corresponding structures, which in particular is formed such that a fine line movement detectable by an observer and/or sensor is generated, wherein the width of the detectable lines is preferably dependent on the sizes and/or lateral dimensions of the pixels.

In the optically variable element shown in FIG. 15, the structures in the individual groups of pixels G, arranged in lines, are designed such that they project in particular incident light in different spatial directions and/or at different predefined solid angles, wherein, preferably by tilting an optically variable element of this type, in dependence on the viewing situation and/or the viewing direction and/or the incident light and/or the direction of incidence of the incident light, in each case adjacent groups of pixels G, arranged in lines, light up one after another, in particular achromatically, in particular in dependence on the tilting direction.

It is also possible that one or more groups of pixels arranged in lines are omitted and/or light up at a random angle, wherein the lighting up of the groups of pixels arranged in lines is preferably generated in any desired sequence. In particular, achromatic fine line morphing effects can also be generated, which are preferably detectable by an observer and/or a sensor.

It is further also possible to generate one or more effects of the following effects detectable by an observer and/or a sensor: freeforms virtually projecting towards or jumping back from an observer and/or sensor; shapes floating virtually in front of or behind the plane spanned by the optically variable element; achromatic fine line movement and transformation; achromatic movement, in particular linear and/or radial achromatic movement; achromatic image flip, in particular double, triple or multiple flips and/or preferably animations comprising several motifs, preferably images; one or more surfaces appearing isotropically matte for an observer and/or sensor; one or more surfaces appearing anisotropically matte for an observer and/or sensor; one or more pixels of the two or more pixels of the at least one pixel array comprising hidden effects, such as for example nanotext; hidden motif (motif hidden or concealed from an observer and/or sensor at a predefined distance and/or in one or more predefined wavelength ranges), in particular hidden text (text hidden or concealed from an observer and/or sensor at a predefined distance and/or in one or more predefined wavelength ranges) and/or hidden images (images hidden or concealed from an observer and/or sensor at a predefined distance and/or in one or more predefined wavelength ranges) in one or more predefined imaging planes or at one or more predefined solid angles and/or distances from the optically variable element.

It is possible, for the generation of a double flip, that to mold a first group of structures which in particular project, diffract and/or scatter incident light achromatically, for example computer-generated hologram structures, in a first group of pixels of the pixel array, wherein these structures of the first group of structures project, diffract and/or scatter incident light achromatically at a first angle of inclination of approximately 30° relative to the surface of the plane spanned by the optically variable element. The pixels of the first group of pixels here preferably form a first motif.

It is further possible, for the generation of a double flip, to mold a second group of structures which in particular project, diffract and/or scatter incident light achromatically, for example computer-generated hologram structures, in a second group of pixels of the pixel array, wherein these structures of the second group of structures project, diffract and/or scatter incident light achromatically at a second angle of inclination of approximately 5° relative to the surface of the plane spanned by the optically variable element. The pixels of the second group of pixels preferably form a second motif.

It is also possible that one or more structures of the one or more structures and/or the structures allocated structures allocated to one pixel of the two or more pixels of the at least one pixel array project, diffract and/or scatter electromagnetic radiation, in particular incident electromagnetic radiation, at a solid angle, in particular a punctiform solid angle.

One or more structures of the one or more structures and/or one or more pixels of the two or more pixels of the at least one pixel array comprising one or more allocated structures of the one or more allocated structures are preferably allocated to two or more groups of structures and/or two or more groups of pixels, in particular wherein the groups of the two or more groups of structures and/or the groups of the two or more groups of pixels differ from each other.

It is possible that two or more groups of structures of the two or more groups of structures and/or two or more groups of pixels of the two or more groups of pixels project, diffract and/or scatter electromagnetic radiation, in particular incident electromagnetic radiation, at identical or different solid angles and/or predefined solid angles, in particular punctiform solid angles and/or predefined solid angles, preferably differently shaped solid angles and/or predefined solid angles.

It is further possible that two or more groups of structures of the two or more groups of structures and/or two or more groups of pixels of the two or more groups of pixels provides an item of optically variable information comprising a 3D effect.

Here, it is further possible that the first motif appears bright and the second motif appears dark, if the optically variable element is detected in particular from the predefined solid angle corresponding to the first angle of inclination. It is further possible that, after a tilting relative to an observer and/or sensor, the optically variable element is aligned such that the optically variable element is detectable in particular from the predefined solid angle corresponding to the second angle of inclination, wherein the second motif preferably appears bright and the first motif appears dark. An effect of this type is preferably also called an image-flip effect.

It is preferably possible that the structures project, diffract and/or scatter the incident light at three or more predefined solid angles, wherein different motifs, in particular images, are allocated in particular in each case to each of the predefined solid angles. Here it is possible, for example, to generate a flip between three or more motifs in dependence on the viewing direction and/or a viewing directions corresponding to the predefined solid angles. In particular, for an observer and/or sensor, an illusion of a continuous and/or jumpy movement of a motif is generated, which appears in particular in the case of a corresponding movement, rotation and/or tilting of the optically variable element. The underlying pixel array is preferably divided into parts which generate the respective motifs and/or one or more pixels of the two or more pixels of the pixel array are subdivided in each case into parts or subpixels, which in each case have different structures which project, diffract and/or scatter the incident light at the predefined solid angles to generate the corresponding motifs.

One or more pixels of the two or more pixels are preferably divided in each case into three, in particular four, further preferably five, parts or subpixels, wherein the parts or subpixels in particular preferably have different structures in each case.

It is possible that one or more of the solid angles, detectable by an observer, of the one or more solid angles or predefined solid angles of the one or more predefined solid angles, at which one or more pixels of the two or more pixels of the at least one pixel array project, diffract and/or scatter incident electromagnetic radiation, follow a function, wherein the function is formed in such a way that an observer detects the solid angles or predefined solid angles as bands of brightness moving like waves, preferably sinusoidally moving bands of brightness.

It is further possible to generate a changing shape of a motif, for example a transformation of one motif, for example the letter sequence “CH”, into a further motif, for example the Swiss cross, which is detectable for an observer and/or a sensor, wherein in particular outlines of a motif which visually increase or decrease in size are possible.

It is further also possible that one or more pixels of the two or more pixels of the at least one pixel array project, diffract and/or scatter at least two views of a motif at different predefined solid angles, wherein in particular at least one stereoscopic image of the motif is detectable for an observer and/or sensor at least at a predefined distance.

On the left-hand side, FIG. 16 shows the strip-shaped security element 1b′ shown in FIG. 1, wherein an observer and/or sensor detects movement effects and/or 3D elements visually virtually jumping out in the viewing direction and/or jumping back from the viewing direction when the security element 1b′ is viewed in particular in reflected light and/or transmitted light.

It is possible that the security document 1d, in or outside the strip-shaped area 1b′, has one or more further optically variable elements.

The strip-shaped security element 1b further comprises two optically variable elements 1a, which in particular in each case have at least one pixel array comprising two or more pixels and are shown enlarged on the right-hand side of FIG. 16.

The strip-shaped security element 1b′ further comprises several security element 8, which are designed as the number sequence “45”, two cloud-like motifs, a motif in the shape of an aircraft, a motif in the shape of a sailing ship and a word sequence “UT” with two horizontal lines through it.

The sun-shaped optically variable element 1a shown top right in FIG. 16 in particular generates an optical effect such that the emergent light preferably appears to an observer and/or sensor to be reflected by the domed surface of the sun 9a. The sun 9a appears to protrude, preferably apparently tangibly, in particular so that an observer expects it to be tangibly or haptically detectable, out of the plane and/or surface spanned by the optically variable element 1a, although the security element is preferably completely even and/or flat here. The optically variable element shown bottom right in FIG. 16 comprises a pixel array, which in particular generates the illusion, in particular the optical illusion of water 9b moving like waves for an observer and/or sensor. When the optically variable element 1a is tilted a band of brightness, which moves from left to right and/or in the opposite direction, preferably appears for an observer and/or sensor.

When the element and/or the at least one pixel array is bent out of shape it is possible that one or more structures of the one or more structures provide an optically variable effect, wherein in particular a first motif is detectable in an unbent state of the element and/or of the at least one pixel array and a second motif is detectable in a bent state of the element and/or of the at least one pixel array.

It is also possible that an image flip is detected by an observer and/or a sensor such that a first motif is detectable in particular in the unbent state and a second motif is detectable in the bent state. In particular, the virtual pixel array is provided in a bent state for calculating the corresponding structures in the virtual pixels and the virtual electromagnetic fields, which are preferably emitted by one or more virtual point field sources, are preferably calculated on the bent virtual pixel array. It is hereby achieved in particular that the one or more predefined solid angles at which the structures project, diffract and/or scatter the incident light is correspondingly compensated for by the local curvature of the optically variable element, preferably in the bent state. If incident light strikes a flat pixel array the pixels of which are designed in particular for a bent state, the motif is preferably projected, diffracted and/or scattered at the one or more predefined solid angles in such a way that, for an observer and/or sensor, the motif preferably cannot be detected completely and/or is only detectable visually distorted.

It is possible that an observer and/or sensor detects one or more of the following effects generated by one or more optically variable elements, in particular the following optical effects generated by one or more optically variable elements: one or more effects in reflection; one or more effects in transmission; combination of the above effects in reflection and in transmission, such as for example different movement effects in reflection and transmission, wherein in particular 50% of the pixels and/or subpixels of at least one pixel array are used for the respective effect in reflection and in transmission, respectively; one or more effects for a bent or unbent state of one or more optically variable elements of the one or more optically variable elements.

It is also possible to mold one or more structures of the one or more structures in such a way that phase shifts of 2×180° in reflection and of 1×360° in transmission occur. A phase shift of this type is preferably exact only at one wavelength, wherein the corresponding effect is preferably color-selective around this wavelength. The effect hereby appears in particular in a clearly defined color for an observer and/or sensor. All above effects, in particular all above optical effects, can be implemented, for example, with a correspondingly defined color in such a manner.

FIG. 17 shows by way of example an achromatic arch comprising a plurality of light points 200, which moves upwards and/or downwards along the direction R′, in particular when the optically variable element is tilted forwards and/or backwards or tilted along the direction R′, up and/or down or along the direction R′ in the figure plane spanned by the x and y directions. The structures in the pixels of the underlying pixel array are in particular designed such that, when the optically variable element is tilted out of the figure plane spanned by the x and y directions by −30° to +30°, incident light preferably generates the illusion of a moving bright arch for an observer and/or sensor.

FIG. 18 shows a first enlarged detail in the upper part and a second, in particular even further enlarged detail of the underlying pixel array comprising pixels with corresponding structures, in the lower part. The framed pixel 2e having the structure 3e has a lateral dimension in the x and y direction in each case of 50 μm.

FIG. 19 shows, in a schematic perspective representation, a movement sequence, detectable for an observer B and/or a sensor S, of an achromatic arch-shaped motif 9c, which moves in the plane spanned by the optical element 1a, in particular along the direction R″, wherein the structures of the pixel array 2 contained in the optically variable element 1a project, diffract and/or scatter the incident light 20 in the direction of the observer B and/or sensor S.

FIG. 20 shows a 3D object in the form of a snail shell 9d, protruding achromatically for an observer and/or sensor from the figure plane, in particular from the plane spanned by the x and y directions. In particular, the structures in the pixels of the underlying pixel array are designed such that incident light generates the illusion of the 3D object. When tilted back and forth and left and right, light and shadow move over the snail for an observer and/or sensor.

FIG. 21 shows a first enlarged detail in the upper part and a second, in particular even further enlarged detail of the pixel array underlying the snail shell 9d shown in FIG. 20 comprising pixels with corresponding structures, in the lower part. The framed pixel 2f having the structure 3f has a lateral dimension in the x and y direction in each case of 50 μm.

FIG. 22 shows a design comprising a 3D model of the portrait 9e of the mathematician and physicist Carl Friedrich Gauβ in 28 different variants and FIG. 23 shows an enlarged detail of FIG. 22, wherein the structures in the pixels of the underlying pixel array are molded here in particular as Fresnel microlens structures, which have been used for the generation of the variants. In particular, in the first line the portraits show, from left to right, an intensifying variation of the 3D-effect strength detectable for an observer and/or sensor. In each case the first four portraits in the further lines in each case show, from left to right, an effect with reference to the corresponding portrait based on structures with a structure depth of 2 μm and in each case the last three portraits in the further lines in each case show, from left to right, an effect with reference to the corresponding portrait based on structures with a structure depth of approximately 1 μm structure depth.

### LIST OF REFERENCE NUMBERS

1a optically variable element
1b security element
1b′ strip-shaped security element
1c decorative element
1d security document
10 substrate
2 pixel array
2aa-2dd, 2e-2f pixel
20aa-20dd emergent light
200 light points
3aa-3dd, 3e-3f structure
30aa, 30ad, 30cc microstructure
31aa, 31ad, 31cc microstructure
4 virtual pixel array
4aa-4dd virtual pixel
6 incident light
9, 9a, 9b, 9c, 9d, 9e motif
91, 92, 93, 94, 95 motif
96, 97 motif
98, 99 motif
Δx, Δy lateral dimension
Δz structure depth
P focal point
F focal plane
f distance
θ, φ, α, Ω angle
S segment
R, R′, R″ direction
G group of pixels
B observer
S sensor
L light source
GF base surface
EF element surface

1. An optically variable element having at least one pixel array comprising two or more pixels, wherein one or more pixels of the two or more pixels of the at least one pixel array have one or more structures, and wherein one or more structures of the one or more structures project, diffract and/or scatter incident electromagnetic radiation at one or more solid angles.

2. The optically variable element according to claim 1, wherein
one or more structures of the one or more structures project, diffract and/or scatter incident electromagnetic radiation achromatically at one or more solid angles.

3. (canceled)

4. The optically variable element according to claim 1, wherein
one or more structures of the one or more structures are allocated to each pixel of the two or more pixels of the at least one pixel array, wherein the one or more structures allocated to a pixel project, diffract and/or scatter incident electromagnetic radiation at one or more predefined solid angles.

5. The optically variable element according to claim 1, wherein
one or more structures of the one or more structures and/or one or more allocated structures of the one or more allocated structures project, diffract and/or scatter at one or more solid angles of the one or more solid angles and/or one or more predefined solid angles of the one or more predefined solid angles, wherein one or more solid angles of the one or more solid angles and/or predefined solid angles of the one or more predefined solid angles projected onto a sphere, arranged around a pixel form one or more, shape.

6. The optically variable element according to claim 5, wherein
one or more shapes of the one or more shapes are open or closed and/or consist of one or more partial shapes.

7. The optically variable element according to claim 1, wherein
one or more of the solid angles, of the one or more solid angles or predefined solid angles of the one or more predefined solid angles at which one or more pixels of the two or more pixels of the at least one pixel array project, diffract and/or scatter incident electromagnetic radiation follow a function, wherein the function is formed in such a way that an observer detects the solid angles or predefined solid angles as bands of brightness moving like waves.

8. The optically variable element according to claim 1, wherein
one or more or all solid angles of the one or more solid angles and/or one or more or all predefined solid angles of the one or more predefined solid angles are up to 70°, in at least one direction, and/or wherein the opening angle of one or more or all solid angles is at most 20°.

9. The optically variable element according to claim 1, wherein
one or more or all solid angles of the one or more solid angles and/or one or more or all predefined solid angles of the one or more predefined solid angles are up to 70°, in at least one direction.

10. The optically variable element according to claim 1, wherein
one or more structures of the one or more structures and/or the structures allocated to one pixel of the two or more pixels of the at least one pixel array are formed in such a way that they provide an item of optically variable information.

11. The optically variable element according to claim 1, wherein
one or more structures of the one or more structures and/or the structures allocated structures allocated to one pixel of the two or more pixels of the at least one pixel array project, diffract and/or scatter electromagnetic radiation, at a solid angle.

12. The optically variable element according to claim 1, wherein
one or more structures of the one or more structures and/or one or more pixels of the two or more pixels of the at least one pixel array comprising one or more allocated structures of the one or more allocated structures are allocated to two or more groups of structures and/or two or more groups of pixels.

13. The optically variable element according to claim 12, wherein
two or more groups of structures of the two or more groups of structures and/or two or more groups of pixels of the two or more groups of pixels project, diffract and/or scatter electromagnetic radiation, at identical or different solid angles and/or predefined solid angles.

14. The optically variable element according to claim 12, wherein
two or more groups of structures of the two or more groups of structures and/or two or more groups of pixels of the two or more groups of pixels provides an item of optically variable information comprising a 3D effect.

15. (canceled)

16. (canceled)

17. (canceled)

18. (canceled)

19. (canceled)

20. (canceled)

21. The optically variable element according to claim 1, wherein
one or more structures of the one or more structures have a grating period smaller than half, of the maximum lateral dimension of the two or more pixels, of the at least one pixel array.

22. The optically variable element according to claim 1, wherein
one or more structures of the one or more structures have a restricted maximum structure depth, wherein the restricted maximum structure depth is smaller than 15 μm.

23. (canceled)

24. (canceled)

25. (canceled)

26. The optically variable element according to claim 1, wherein
one or more structures of the one or more structures are formed as achromatically diffracting structures, and/or wherein more than 70% of the pixels, of the two or more pixels of the at least one pixel array comprises at least two grating periods.

27. The optically variable element according to claim 1, wherein
in one or more pixels of the two or more pixels in the at least one pixel array the achromatically diffracting structures are superposed with further microstructures and/or nanostructures.

28. The optically variable element according to claim 1, wherein
one or more structures of the one or more structures are formed as convexly or concavely acting microlenses and/or partial areas of microlenses.

29. The optically variable element according to claim 1, wherein
one or more structures of the one or more structures are formed as cylindrical lenses.

30. The optically variable element according to claim 1, wherein
one or more structures of the one or more structures are formed as Fresnel microlens structures.

31. (canceled)

32. (canceled)

33. (canceled)

34. (canceled)

35. The optically variable element according to claim 1, wherein
one or more structures of the one or more structures are provided with a metal layer and/or absorb incident electromagnetic radiation.

36. The optically variable element according to claim 1, wherein
one or more structures of the one or more structures have an HRI layer.

37. The optically variable element according to claim 1, wherein
one or more structures of the one or more structures project, diffract and/or scatter incident electromagnetic radiation pseudo-randomly or randomly in all spatial directions.

38. The optically variable element according to claim 1, wherein
when the element and/or the at least one pixel array is bent out of shape, one or more structures of the one or more structures provide an optically variable effect.

39. A security document comprising one or more optically variable elements according to claim 1.

40. (canceled)

41. (canceled)

42. (canceled)

43. A methods for producing an optically variable element comprising:
providing at least one virtual pixel array comprising two or more virtual pixels,
allocating at least one solid angle to one or more virtual pixels of the two or more virtual pixels of the at least one virtual pixel array,
arranging one or more virtual field sources in and/or on at least one area or at least one segment of the at least one allocated solid angle, wherein the at least one area or the at least one segment of the at least one allocated solid angle is arranged at a first distance from the one or more virtual pixels of the two or more virtual pixels of the at least one virtual pixel array,
calculating one or more virtual electromagnetic fields emanating from the one or more virtual field sources at a predefined distance from the one or more virtual pixels of the two or more virtual pixels of the at least one virtual pixel array in and/or on the one or more virtual pixels of the two or more virtual pixels of the at least one virtual pixel array and/or in and/or on the surface spanned by the at least one virtual pixel array,
calculating one or more phase images for the one or more virtual pixels of the two or more virtual pixels of the at least one virtual pixel array from a total virtual electromagnetic field consisting of the superposition of the one or more virtual electromagnetic fields in and/or on the one or more virtual pixels of the two or more virtual pixels of the at least one virtual pixel array and/or in and/or on the surface, spanned by the at least one virtual pixel array,
calculating virtual structure profiles for the one or more virtual pixels of the two or more virtual pixels of the at least one virtual pixel array from the one or more phase images,
forming the virtual structure profiles of the one or more virtual pixels of the two or more pixels of the at least one virtual pixel array in and/or on a substrate as at least one pixel array comprising two or more pixels, wherein one or more pixels of the two or more pixels of the at least one pixel array have one or more structures, for providing the optically variable element.

44. (canceled)

45. (canceled)

46. (canceled)

47. (canceled)

48. (canceled)

49. (canceled)

50. The method according to claim 43, wherein
a first group of one or more virtual field sources of the one or more virtual field sources cannot be projected onto a screen from a distance of 0.3 m, and/or a second group of one or more virtual field sources of the one or more virtual field sources can be projected onto a screen from a distance of 1.0 m.

51. The method according to claim 43, wherein
the virtual electromagnetic field which emanates from one or more of the virtual field sources, has the same intensity and/or the same intensity distribution over the at least one allocated solid angle and/or over the at least one area of the at least one allocated solid angle.

52. The method according to claim 43, wherein
the virtual electromagnetic field which emanates from one or more of the virtual field sources, has an intensity distribution over the at least one allocated solid angle and/or over the at least one segment and/or over the at least one area of the at least one allocated solid angle, which has a Gaussian or super-Gaussian distribution.

53. The method according to claim 43, wherein
the virtual electromagnetic field which emanates from two or more of the virtual field sources, has different intensities and/or different intensity distributions over the at least one allocated solid angle and/or over the at least one segment and/or over the at least one area of the at least one allocated solid angle.

54. (canceled)

55. (canceled)

56. The methods according to claim 43, wherein
the virtual electromagnetic field Uᵢ emanating from an i-th virtual point field source at the location (xᵢ, yᵢ, zᵢ) of at least one coordinate (xₕ, yₕ, zₕ), in and/or on one or more virtual pixels of the two or more virtual pixels of the at least one virtual pixel array and/or in and/or on the surface, spanned by the at least one virtual pixel array, is calculated by means of the equation
Uᵢ(xₕ,yₕ)=exp(ikr)/r,r=\sqrt{(xₕ−xᵢ)²+(yₕ−yᵢ)²+zᵢ²},

57. (canceled)

58. (canceled)

59. The methods according to claim 56, wherein
the total virtual electromagnetic field Uₚ in and/or on one or more virtual pixels of the two or more virtual pixels of the at least one virtual pixel array and/or in and/or on the surface, spanned by the at least one virtual pixel array, is calculated by means of the equation
$${U}_{p} ( {x}_{p} , {y}_{p} ) = {U}_{r}^{*} ( {x}_{p} , {y}_{p} ) {\sum }_{i = 1}^{{N}_{p}} {U}_{i} ( {x}_{p} , {y}_{p} ) ,$$
wherein the virtual electromagnetic fields Uᵢ emanating from i=1, . . . , Nₚ virtual point field sources at least at one coordinate (xₚ, yₚ, zₚ=0) and/or the optional reference wave Uᵣ*, are calculated at least at one point or, for the parameters (xₚ, yₚ), in and/or on the one or more virtual pixels of the two or more virtual pixels of the at least one virtual pixel array and/or in and/or on the surface, spanned by the at least one virtual pixel array.

60. (canceled)

61. (canceled)

62. (canceled)

63. A method for producing a security document.
wherein one or more optically variable elements are applied to the security document and/or to one or more layers of the security document and/or are introduced into the security document and/or into one or more layers of the one or more layers of the security document as a laminating film and/or as an embossing film.
